(19) United States
(12) Patent Application Publication
(10) Pub. No.: US 2010/0304995 A1
(43) Pub. Date: Dec. 2, 2010

(54) Arrays and Methods for Reverse Genetic Functional Analysis

(76) Inventors: LI SHEN, BOYDS, MD (US); SONG TIAN, GAITHERSBURG, MD (US)

Correspondence Address: GREENLEE SULLIVAN P.C., 4875 PEARL EAST CIRCLE, SUITE 200, BOULDER, CO, 80301, US

(21) Appl. No.: 12/785,198

(22) Filed: May 21, 2010

Related U.S. Application Data
(60) Provisional application No. 61/180,777, filed on May 22, 2009.

(51) Int. Cl. C40B 30/04; C40B 40/00; C40B 40/08; C40B 40/10; C40B 40/12

(52) U.S. Cl. 506/9; 506/13; 506/17; 506/18; 506/19

(57) ABSTRACT

Provided are methods, kits and arrays for carrying out relative measurement of an analyte of interest in a biological sample. As specifically exemplified, there is an array of stabilized, desiccated cDNA preparations, each at a defined location within the array, where those cDNAs were prepared from cells treated with a particular condition believed to modulate at least one gene of interest. Detection can be via Real Time Polymerase Chain Reaction using an appropriate reaction mixture and primers specific for a coding sequence of interest, and a greater relative amount of a RT PCR product from a control preparation reflects greater gene expression in response to the test condition whereas a lower amount of RT PCR product reflects an inhibitory effect on expression of the coding sequence of interest as a result of the application of the test condition.

### CROSS-REFERENCE TO RELATED APPLICATIONS

This application claims benefit of U.S. Provisional Application 61/180,777, filed May 22, 2009; which application is incorporated by reference herein to the extent that there is no inconsistency with the present disclosure.

### STATEMENT REGARDING FEDERALLY SPONSORED RESEARCH OR DEVELOPMENT

The Sequence Listing filed herewith is incorporated by reference.

### REFERENCE TO SEQUENCE LISTING, A TABLE, OR A COMPUTER PROGRAM LISTING COMPACT DISK APPENDIX

The Sequence Listing filed herewith is incorporated by reference herein.

### BACKGROUND

The disclosure relates to molecular biology, especially to arrays, kits and methods for carrying out reverse genetic analyses to assess gene product function and interactions with other genes and their expression.

Traditional microarrays have facilitated the elucidation of gene expression changes based on downstream mechanisms of action. The results of which have led, in large part, to the explosive growth of the field of functional genomics that analyzes the downstream effects of these changes (Verducci et al, 2006, Physiol Genomics 25:355). However, there is an unmet need for a similar array-based benefit to identification of upstream functional modulators of cellular processes such as intracellular signal transduction and gene transcription. This upstream approach, commonly referred to as “reverse genetics”, has a well established history but has been severely limited in its scope by its reliance on tradition genetic manipulation, such as cross-breeding or transgenic organism production, to create altered physiological conditions (Silva et al, 2004, Oncogene 23:8401).

Functional modulation of cellular processes has been facilitated recently by the discovery and application of various targeted forms of RNAi, especially siRNA and shRNA. The depletion or “knock down” of specific intracellular proteins within living cells creates an in vivo situation that uniquely alters cellular physiology. The physiological response to this change in a cell reflects the targeted protein's most closely associated biological functions and those dependent upon the targeted protein. While siRNAs and shRNAs targeting the expression of many of the proteins encoded by mammalian genomes have been designed, their use in a library format has been limited because of the extensive cell culture and sample preparation requirements for analysis of each target in the library (Sachse and Echeverri, 2004, Oncogene 23:8384; Ovcharenko et al, 2005, RNA 11:985).

With the advent of targeted “knock down” technology that bypasses the requirement for the stable genome integration necessary for classical “knock out” experiments, reverse genetics and the associated analytical strategies have experienced a rise in popularity. However, up to now, each investigative group working on similar biological questions has had to independently do its own cell culture, RNAi treatment and subsequent sample preparation from the treated and control cell cultures. The labor intensive and relatively expensive nature of these steps has limited the size of the sample library that could be analyzed, and there has been significant redundant effort across the scientific community (Silva et al, 2008, Science 319:617).

The long standing practice of using immortalized cultured cells for mechanistic studies has led to the common use of a relatively small number of cell lines by many investigators. If standardized preparative steps were performed on these widely used cell lines and on a scale that would meet the scientific community's needs as a whole, research productivity and economy could be significantly increased, resulting in accelerated discoveries within specific application fields and associated benefits to society.

Reverse genetics experiments generally focus on specific phenotypic analyses of cellular function and/or pathways by over-expressing or under-expressing components of the pathway being studied (Ziauddin and Sabatini, 2001, Nature 411:107; Fuchs and Boutros, 2006, Briefings in Functional Genomics and Proteomics 5(1):52). This is often evaluated at several levels, starting with basic metrics such as viable cell number, followed by more specific assays, including enzyme function assays for key protein targets such as kinases and caspases. While measuring or detecting changes in levels of mRNAs encoding specific genes of interest (GOD can very specifically and sensitively reflect phenotypic effects, mRNA measurements are relatively infrequently used in reverse genetics profiling because they require significantly greater technical sophistication and more labor for sample handling and data processing than do typical enzyme function assays or cellular reporter assays.

For measuring mRNA levels, reverse-transcription, real-time PCR(RT-qPCR) offers a major advantage in this circumstance because it is much less labor intensive than microarrays. Although microarrays can allow the detection of thousands of mRNA detections in parallel, this is not generally advantageous in a reverse genetics experiment because, by the definition of such a scheme, the genes of interest are already known and are relatively few in number compared to the tens of thousand of possible candidate genes in a mammalian genome.

Advances in experimental design, control assays and instrumentation have facilitated the use of an array format to the field of RT-qPCR. PCR arrays of 84 to 384 mRNA targets built around a downstream analysis format of multiple different assays, all pre-dispensed and stabilized on a single plate, where those targets are now increasing available from a variety of sources.

While these PCR ready arrays for individual samples have been produced, no one has yet recognized the significance of utilizing this technology to create a commercially available, standardized and quality controlled sample array for investigations of physiological function and gene expression.

### BRIEF SUMMARY OF THE INVENTION

The present disclosure provides equipment, kits and detection methods for research into gene control networks in a cell or cell line of interest. The arrays distributed in devices for carrying out multiple assays, such as RT-qPCR, in parallel, comprise stabilized cDNA preparations at defined locations within the arrays. Typically the devices are microwell plates with 84, 96 or 384 individual wells each well constituting one element in the array. Advantageously, a relatively small number of elements within the array comprise samples designed for control reactions, so that sample integrity, reagents and detection methods are verified along with performance of the test reactions. A kit for carrying out RT-qPCR advantageously also includes a “master mix” for carrying out the RT-qPCR reactions and an array in which each element comprises stabilized cDNA preparations prepared from cells treated in a particular defined fashion, for example, a cultured cancer cell line that has been treated in parallel with a series of chemotherapeutic agents or siRNAs or other compounds) with gene-modulating activity designed for particular genes of interest. The consumer then carries out RT-PCR assays using primers of his/her choice, specific to a gene of choice, in the parallel elements, allowing a variety of gene expression questions to be addressed in a single multi-element array format using cDNA prepared from the same starting cultured cells, thus eliminating one source of variability. In this embodiment, it is possible to determine the response of genes of choice to the chemotherapeutic agent treatments or siRNAs. The inclusion of certain control elements allows validation of the result.

In another embodiment, the cultured cells are treated in parallel with a series of siRNAs and cDNA is separately prepared and stabilized in elements of the multiwell plate at defined locations. Control elements are also included for assay validation. In the specifically exemplified embodiment, the parallel treatments were siRNAs directed to a set of transcription factors whose coding sequences were known.

In an embodiment, cDNAs are prepared and stabilized at defined locations after parallel siRNA treatments specific for a series of apoptotic genes have been carried out.

In embodiments disclosed herein, there is (a) a kit which comprises an array comprising, at defined locations, two or more stabilized biological samples comprising an analyte of interest and optionally further comprising trehalose, wherein the samples are desiccated; and a mixture of reagents capable of detecting the analyte of interest in a container separate from the array. In the kit, the analyte of interest is selected from the group consisting of cDNA, DNA, RNA, protein and carbohydrate, and in a particular embodiment, the analyte of interest is cDNA. When contains cDNA as the analyte of interest, it is prepared from cells treated in parallel with an agent or condition which modulates expression of at least one gene of interest. In a kit herein, the agent which modulates the gene of interest is siRNA specific to said gene, and in a kit described herein, at least one gene of interest is set forth in Table 1.

In a kit wherein the gene of interest is one listed in Table 1, and siRNA is the agent which modulates expression of the gene of interest, at least one siRNA comprises oligonucleotides in pairwise combinations selected from the group consisting of SEQ ID NOs:1, 3 and 4, 5 and 6, 7 and 8, 9 and 10, 11 and 12, 13 and 14, 15 and 156, 17 and 18, 19 and 20, 21 and 22, 23 and 24, 25 and 26, 27 and 28, 29 and 30, 31 and 32, 33 and 34, 35 and 36, 37 and 38, 39 and 40, 41 and 42, 43 and 44, 45 and 46, 47 and 48, 49 and 50, 51 and 52, 53 and 54, 55 and 56, 57 and 58, 59 and 60, 61 and 62, 63 and 64, 65 and 66, 67 and 68, 69 and 70, 71 and 72 73 and 74, 75 and 76, 77 and 78, 79 and 80, 81 and 82, 83 and 84, 85 and 86, 87 and 88, 89 and 90, 91 and 92, 93 and 94, 95 and 96, 97 and 98, 99 and 100, 101 and 102, 103 and 104, 105 and 106, 107 and 108, 109 and 110, 111 and 112, 113 and 114, 115 and 116, 117 and 118, 119 and 120, 121 and 122, 123 and 124, 125 and 126, 127 and 128, 129 and 130, 131 and 132, 133 and 134, 135 and 136, 137 and 138, 139 and 140, 141 and 142, 143 and 144, 145 and 146, 147 and 148, 149 and 150, 151 and 152, 153 and 154, 155 and 156, 157 and 158, 159 and 160, 161 and 162, 163 and 164, 165 and 166 and 167 and 168.

In a kit provided herein, the array comprises at least one sample is prepared from cells treated with a negative control siRNA comprising oligonucleotides in pairwise combination selected from the group consisting of SEQ ID NOs:169 and 170, 171 and 172, 173 and 174, and 175 and 176.

Further provided herein are methods for detecting modulation of gene expression in a cell of interest in response to a test condition, said method comprising the steps of a) selecting a panel of treatments, optionally from 4 to 384; b) incubating the cell of interest in parallel under test conditions effecting the panel of treatments for a time sufficient to allow modulation of gene expression in response to at least one treatment within the panel of treatments, and optionally further comprising incubating a cell of interest in parallel with at least one negative control condition; c) isolating a biological sample comprising an analyte of interest from the cells after step b; d) dispensing the biological samples of step c at indexed positions of an array vessel; e) immobilizing and/or stabilizing the biological samples in the array vessel; f) optionally storing and optionally distributing the array of samples; g) applying to the array a mixture of reagents capable of detecting the analyte of interest within the biological sample in an analysis reaction; and h) measuring output of the analysis reaction of step g, whereby modulation of expression of a gene of interest is determined when the output of the analysis reaction for the analyte of interest is different in the biological sample prepared from cells incubated under the test conditions than in a biological sample from control cells not treated with a test condition which modulates expression of the gene of interest.

In a method herein, wherein the test condition is treatment with at least one RNA molecule of from 18 to 100 nucleotides, which when introduced into or expressed in a cell inhibits transcription of a target sequence of the gene of interest complementary to a sequence of at least 9 nucleotides of the RNA molecule.

In a method provided herein, the analyte of interest is a cDNA of defined (known) sequence, and the analysis reaction is, in an embodiment, a Real Time Polymerase Chain Reaction.

In a method provided herein, the treatment is an siRNA or shRNA, wherein said siRNA or shRNA is specific to the gene of interest and wherein said siRNA or shRNA modulates expression of at least one gene of interest by inhibiting expression of said gene of interest. In a particular embodiment of the methods herein, the treatment is an siRNA or shRNA complementary to a mRNA encoding a transcription factor. In such methods, the siRNA or shRNA is specific to one or more of the sequences encoding the transcription factors set forth in FIG. 1.

In methods wherein the modulator of gene expression is an siRNA, the siRNA used to modulate expression of a human transcription factor can comprise oligonucleotides in pairwise combinations selected from the group consisting of SEQ ID NOs:1 and 2, 3 and 4, 5 and 6, 7 and 8, 9 and 10, 11 and 12, 13 and 14, 15 and 16, 17 and 18, 19 and 20, 21 and 22, 23 and 24, 25 and 26, 27 and 28, 29 and 30, 31 and 32, 33 and 34, 35 and 36, 37 and 38, 39 and 40, 41 and 42, 43 and 44, 45 and 46, 47 and 48, 49 and 50, 51 and 52, 53 and 54, 55 and 56, 57 and 58, 59 and 60, 61 and 62, 63 and 64, 65 and 66, 67 and 68, 69 and 70, 71 and 72, 73 and 74, 75 and 76, 77 and 78, 79 and 80, 81 and 82, 83 and 84, 85 and 86, 87 and 88, 89 and 90, 91 and 92, 93 and 94, 95 and 96, 97 and 98, 99 and 100, 101 and 102, 103 and 104, 105 and 106, 107 and 108, 109 and 110, 111 and 112, 113 and 114, 115 and 116, 117 and 118, 119 and 120, 121 and 122, 123 and 124, 125 and 126, 127 and 128, 129 and 130, 131 and 132, 133 and 134, 135 and 136, 137 and 138, 139 and 140, 141 and 142, 143 and 144, 145 and 146, 147 and 148, 149 and 150, 151 and 152, 153 and 154, 155 and 156, 157 and 158, 159 and 160, 161 and 162, 163 and 164, 165 and 166 and 167 and 168.

In the present method where there is an siRNA as the treatment which modulates gene expression, there can be in parallel, a negative control condition which is negative control siRNA comprising oligonucleotides in pairwise combination selected from the group consisting of SEQ ID NOs:169 and 170, 171 and 172, 173 and 174, and 175 and 176.

In a method provided wherein, the inhibition of expression of a human transcription factor can be assessed using a pair of oligonucleotide primers in a polymerase chain reaction assay, wherein the pair of oligonucleotide primers comprise sequences selected from the group consisting of SEQ ID NOs:177 and 178, 179 and 180, 181 and 182, 183 and 184, 185 and 186, 187 and 188, 189 and 190, 191 and 192, 193 and 194, 195 and 196, 197 and 198, 199 and 200, 201 and 202, 203 and 204, 205 and 206, 207 and 208, 209 and 210, 211 and 212, 213 and 214, 215 and 216, 217 and 218, 219 and 220, 221 and 222, 223 and 224, 225 and 226, 227 and 228, 229 and 230, 231 and 232, 233 and 234, 235 and 236, 237 and 238, 239 and 240, 241 and 242, 243 and 244, 245 and 246, 247 and 248, 249 and 250, and 251 and 260.

In a method provided herein, the treatment which modulates expression of a gene can be a siRNA or shRNA specific for inhibiting expression of at least one gene encoding an apoptosis factor.

In a method herein, when the biological samples contain protein and/or carbohydrate as the analyte of interest, expression can be measured using an immunological detection method, for example a fluorescent or enzyme-linked immunoassay.

### BRIEF DESCRIPTION OF THE DRAWINGS

FIG. 1 shows the effects of inhibition of expression of a set of transcription factors on the levels of CDKN1A mRNA in cultured MCF-7 human breast cancer cells. The experiments were performed in parallel by reverse transfection of siRNAs targeting 42 transcription factors (see Table 1) and controls for sufficient time to allow phenotypic expression in terms of resulting changes in expression of a particular transcription factor and any genes controlled, positively or negatively, by each transcription factor. Then treated with 300 μM 5-fluorouracil for 6 hours to induce CDKN1A gene expression. cDNAs were prepared from the parallel cell cultures after the expression time and were dispensed and dried into multiple array vessels suitable for real-time PCR. Then PCR reagents (master mix with SYBR Green I) were added along with primers specific to CDKN1A (cyclin dependent kinase inhibitor 1a, p21, Cip1) to determine the effect on expression of the inhibition of the various transcription factors in the presence of 5-fluorouracil. Each bar represents the amount of CDKN1A mRNA produced after inhibition of the expression of a particular transcription factor relative to negative control siRNA. The results show a general trend for many of the transcription to be required for full expression of CDKN1A and six transcription factors (ATF1, HSF1, MYC, NFAT5, SMAD4 and TP53) with “knock downs” that reduce CDKN1A mRNA more than a factor of two below the control (<0.5 fold). The results also show one transcription factor, ELK1, that when knocked down allows for greater expression of CDKN1A mRNA indicating that ELK1 serves as a transcriptional repressor for the CDKN1A gene.

### DETAILED DESCRIPTION OF THE INVENTION

The method and kits disclosed herein provide the means by which an investigator can rapidly and easily allow determination of which proteins or applied compounds play a role in regulating the expression of a specific gene or phenotype of interest in a particular cell line commonly referred to as reverse genetics. Of particular significance is the arraying of many biological samples (2 or more) into a multiplex ready-to-analyze format wherein the sample source is selected as subset of biological molecules isolated from commonly utilized organisms or cell lines. Thus, the preparation of sample materials for the manufacturing of the “Reverse Array” offers better standardization of data and results as well as a substantial savings in time and effort for scientists. While a specific embodiment uses RT-qPCR to measure mRNA levels within total RNA or cDNA fractions from the samples, the concept encompasses the measurement of other types of biomolecules, such as proteins or carbohydrates or other analyte, from within the samples.

At its most basic level, the disclosure teaches growing replicate sets of living cells (either in culture or in a multicellular organism) and treating each replicate set of cells with one member of a panel of substances. After an appropriate period of time for the treatment, a fraction of biomolecules of interest from each set of cells is isolated in a manner suitable for a specific method of analysis. The biomolecules from each set of cells are immobilized onto a suitable assay support matrix at an indexed position, according to the sample origin, to create a sample array. The method of immobilization and subsequent processing provide stability to the chosen analyte facilitating storage and distribution of the arrayed samples. The array of biomolecule samples is then subjected to the specified analytical method to generate data that can be used to answer questions about specific biological responses of choice within the cells to the treatments.

It is expected that the number of replicates of living cells would generally be greater than 3 (more commonly 10 or more) and the panel of test substances will be greater than 2. The treatment substances will generally be compounds or mixtures of compounds hypothesized to alter the biology of the cells. A subset of the treatments would be experimental controls using reference compounds or mixtures of compounds with either well characterized known responses or no anticipated biological response to serve as references for comparison. Specific treatments envisioned for this invention include, but are not limited to, drugs or drug candidates, shRNA/siRNAs, toxic compounds, hormones, immuno-regulatory molecules such as cytokines, nucleic acid constructs that confer over expression of specific cellular components and other cellular regulating molecules. Isolated biomolecules fractions will most likely be nucleic acids (including but not limited to cDNAs, mRNAs, miRNAs, ncRNAs, piRNAs, methylated DNAs, protein complexed DNAs) or proteins (including whole cell lysates, subcellular or other fractions) but may also be carbohydrates or lipids or any combination or any other cellular fraction containing a species of molecule having physiological relevance for which an assay has been developed. Subsequent analytical methods are biomolecule specific tests that are suitable to be performed in parallel, especially in a microtiter plate or similar setting. For nucleic acids candidate analysis methods include, but are not limited to, real-time PCR, while for proteins the candidate methods include, but are not limited to, immunoassay, enzymatic assays and mass spectrometry analysis.

Of particular importance is the combination of siRNA mediated knock-down of expression of individual mRNAs and their encoded proteins performed on a library scale (e.g. tens or hundreds of protein targets) and the phenotype measured by RT-qPCR. Changes in mRNA expression levels as a primary phenotypic marker takes advantage of the widespread presence and parallel throughput capabilities of real-time PCR instrumentation readily available to the art. Specifically exemplified siRNA sequences are provided herein.

Advantageously, the present method comprises selecting a library of siRNAs for individually knocking down a set of related protein targets and then delivering the siRNAs individually, or in sets targeting the same mRNA(s), to eukaryotic cells growing in culture. After a time in culture that is sufficient for the effects of the siRNAs to “knock down” mRNA levels of their target genes with resulting decreases in gene products so as to produce a change in the cellular physiology, total RNA is isolated from the cultured cells. The quality of the total RNA is assessed by size and integrity; then each sample is subjected to reverse transcription to create stable cDNA copies of each RNA in the sample. The cDNA is first analyzed for concentration and then quality using RTC, GDC qPCR control assays (SABiosciences, Frederick, Md.) along with at least one “housekeeping” gene assay such as ACTB (actin B). The final quality control assessment for the sample's cDNA is used with siRNA target specific qPCR assays to confirm the targeted mRNA knock down efficiency of at least 70% for each sample. Samples passing relevant quality criteria are assembled into an indexed source material (cDNA) array that reflects the content of the original library of siRNAs to form a Sample Library. Appropriate buffers, consisting principally of but not limited to aqueous salt and sugar solutions, are mixed with each library sample to facilitate its dispensing and stabilization for storage and distribution. Aliquots of each Sample Library member as well as a small number of control or reference cDNA samples are arrayed into replicate real-time PCR plates to create the Reverse Array and processed to complete the stabilization requirements, generally by drying, freezing or lyophilization.

A microtiter plate containing the samples and for use in the methods as described herein is characterized by well and subwell spacing and dimensions which conform to the SBS standard for microplates. The microtiter plate may comprise (or be formed of) one or more of polystyrene, polypropylene, high-density polypropylene, low-density polypropylene, a cycloalkene or polycarbonate. In an embodiment the microtiter plate comprises polypropylene. A microtiter (microwell plate) useful in the present methods may contain 96 or 384 wells, for example, and while the microwell plate may conform to the SBS standard, other configurations and specifications may apply. Further, the microwell plate may contain a lid, sealing film or other closure.

The Reverse Array is used by preparing a real-time PCR premix of PCR primers for an mRNA or cDNA of interest and real-time PCR master mix solution. This is dispensed uniformly across all the wells of the Reverse Array plate allowing the stabilized cDNA be resuspended into the reaction mixture. The array plate is sealed by an appropriate method and material for real-time PCR, and it is subjected to thermal cycling and data acquisition on a real-time PCR instrument. Analysis of the real-time PCR reactions is performed according the instrument manufacturer's instructions to obtain Ct values. The Ct value for each Sample Library member is compared to the Ct value for a normal, control sample to determine whether the decrease in expression of the targeted gene alters the expression of the gene of interest.

The value of the present methods is that investigators only need to perform the real-time PCR steps which are much easier and less labor-intensive than the steps needed to generate the cell cultures and cDNAs of the Sample Library. While it is anticipated that the cells most commonly used in the process will be mammalian, especially human, marine or rat, the starting cells can be from any source for which sufficient genomic information is available to design targeted RNAi oligonucleotides and qPCR assay primers for the appropriate genes of interest in that organism.

While a useful embodiment starts with a library of siRNA treatments of the cells, this method could also be used with other libraries or panels of biological function modifying substances, including but not limited to small molecules such as drugs, inflammatory stimuli, toxins, extracellular environment conditions like temperature or oxygen concentration or materials or infectious agents. In addition, while a method embodiment requires isolation of RNA and detection of changes in levels of particular RNAs by real-time PCR, other biological fractions of the same treated cell culture library can be prepared and analyzed by a technique appropriate for that material. For example, soluble proteins can be extracted, and amounts of specific proteins can be measured by ELISA.

In the specific example provided herein, the genes subjected to knock-down by siRNA are listed in Table 1 along with references to sequence information which is available to the public. Gene-specific siRNA and primer sequences are provided in Tables 2 and 3 and in SEQ ID NOs:1-176 and SEQ ID NOs:177-260, respectively.

“Knock down”, as used herein, is the term used to describe the results of inducing an RNAi event using an siRNA or shRNA specifically targeting an RNA transcript to induce the degradation of the transcript.

“Knock down efficiency,” as applied to the present reverse genetic analytic methods and devices, is the percentage decrease in the level of targeted mRNA due to the siRNA/shRNA treatment.

A “Knock out” is the result of the manipulation of germ line DNA to inactivate or delete all or part of a specific structural gene that eliminates the functional expression of that protein in the organism or that prevents the functioning of any gene product from the affected gene.

“siRNA” (short interfering RNA, small interfering RNA or silencing RNA) as known to the art, is a double stranded nucleic acid of 17 to 27 ribonucleotides which, when present in cells or an appropriate cell-fee reaction, inhibits the transcriptional and/or translational expression of target gene with which there is at least about 90%, but more often 100%, nucleotide sequence identity.

“Negative Control siRNA”, as used herein, is an siRNA oligonucleotide, usually a ribonucleotide and optionally containing non-naturally occurring and/or chemically modified nucleotides, wherein the siRNA oligonucleotide consists of a sequence of nucleotides that does not have any significant homology to any known transcript in the genome of the organism being studied, also known as a scrambled sequence siRNA. Sequences of such negative control siRNAs are provided in pairs SEQ ID NOs; 169 and 170, 171 and 172, 173 and 175 and 175 and 176

“Reverse Array”, in the present context, is a reverse genetics mode array of sample materials generated from broadly used cell lines and commonly employed physiological modulators. Following a standardized series of preparative steps, the sample materials are dispensed into indexed elements or positions and stabilized to allow convenient distribution and use by biological investigators. At least one element on the array contains sample material prepared from control, untreated samples for comparison. The array also includes control elements (such as wells) so that consistent performance of the preparative and analytical chemistry and instrumentation can be assessed, including those containing cDNA prepared from cells not treated with siRNA, those treated with an irrelevant siRNA and those directed to the expression of at least one housekeeping gene such as ACTB (actin B).

“Element” as applied to the present disclosure, is a single experimental data point in an array, such as in a Reverse Array. An element comprises a single sample or analyte reagent placed at a position within the array. Each position is indexed within the array in a manner suitable to correlate the data from the element with appropriate annotations about the sample or analyte identity. In the context of array (multiplex) experiments, one element is a singleplex experiment.

“Sample Library”, as applied to the present disclosure, is the library of samples from which the materials dispensed into the reverse genetic array. The library can vary in number and targeted content as well as physiological modulator applied to the cells in culture.

U.S. Published Application No. 2009/0069200 and U.S. application Ser. No. 12/249,791, filed Oct. 10, 2008, are incorporated by reference herein.

All references throughout this application, for example patent documents including issued or granted patents or equivalents; patent application publications; non-patent literature documents and other source materials; are incorporated by reference herein in their entireties, as though individually incorporated by reference, to the extent that there is no inconsistency with the present disclosure (for example, a reference that is partially inconsistent is incorporated by reference except for the partially inconsistent portion of the reference).

All patent and nonpatent publications mentioned in the specification indicate the level of skill of those skilled in the art to which this invention pertains. References cited herein are incorporated by reference, in part, to indicate the state of the art, and it is intended that this information can be used, if needed, to exclude and/or disclaim specific embodiments that are in the prior art. For example, when a compound is claimed, it should be understood that compounds known in the prior art are not intended to be included in the claim.

Although the description herein contains certain specific information and examples, these should not be construed as limiting the scope of the invention but rather as providing illustrations of some of the presently preferred embodiments of the invention. For example, thus the scope of the invention should be determined by the appended claims and their equivalents, rather than by the examples given. When a group of substituents is disclosed herein, it is understood that all individual members of those groups and all subgroups, including any isomers and enantiomers of the group members, and classes of compounds that can be formed using the substituents are disclosed separately. When a compound is claimed, it should be understood that compounds known in the art including the compounds disclosed in the references disclosed herein are not intended to be included. When a Markush group or other grouping is used herein, all individual members of the group and all combinations and subcombinations possible of the group are intended to be individually included in the disclosure.

Every formulation or combination of components or steps described or exemplified can be used to practice the invention, unless otherwise stated. Specific names of compounds or procedures are intended to be exemplary, as it is known that one of ordinary skill in the art can name the same compounds or procedures differently. One of ordinary skill in the art appreciated that methods, method steps, cells, molecules, materials, genes, proteins, synthetic methods, and the like other than those specifically exemplified can be employed in the practice of the invention without resort to undue experimentation. All art-known functional equivalents, of any such methods, device elements, cells, genes, proteins, materials, synthetic methods, and steps are intended to be included within the scope of this invention. Whenever a range is given herein, for example, a temperature range, a time range, or a composition range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The terms and expressions which have been employed are used as for description and not for limitation, and there is no intention in the use of such terms and expressions to exclude any equivalents of the features or steps shown and described, and it is recognized that various modifications are possible within the scope of the invention as claimed. Thus, it should be understood that although the present invention has been specifically disclosed by certain embodiments and optional features, modification and variation of the aspects disclosed may be achieved by those skilled in the art, and that such modifications and variations are considered to be within the scope of this invention as defined by the appended claims.

In general the terms and phrases used herein have their art-recognized meaning, which can be found by reference to standard texts, journal references and the like as known to those skilled in the art.

### Example 1

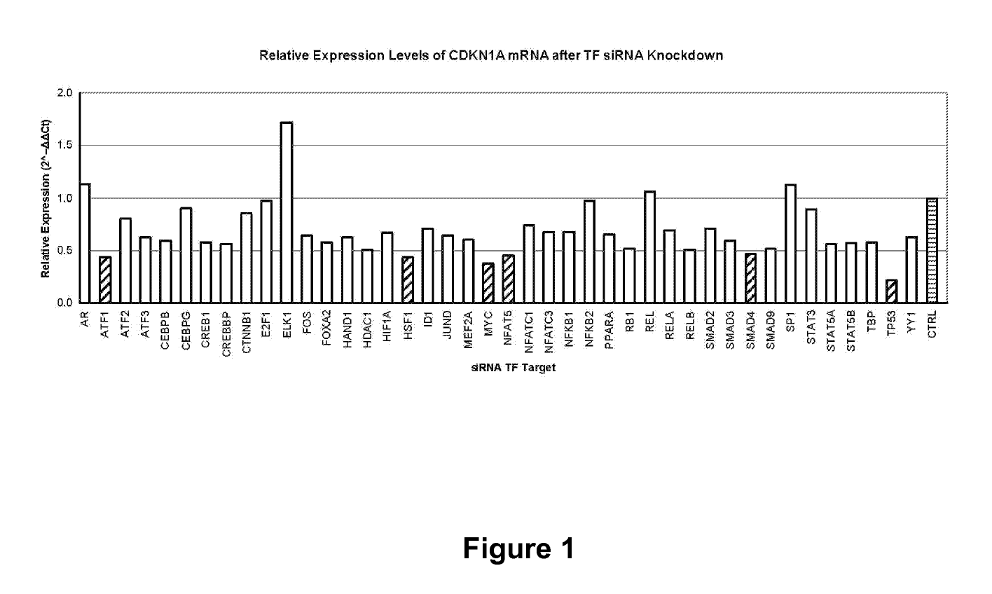

A panel of siRNAs targeting 42 human transcription factors (Table 1) was selected along with four cell culture controls, specifically a negative control siRNA, a mock transfection, a transfection efficiency monitor and an assay background control, (SAH-075A; SureSilencing siRNA Array for human transcription factor signaling pathways, SABiosciences, Frederick, Md.) and transfected into parallel aliquots (1.2×10⁴ cells) of MCF-7 human breast cancer cells (American Type Culture Collection, Manassas, Va.) by the reverse transfection method provided by the supplier using INSTANTFECT™ transfection reagent (PGR-Solutions, Bridgeville, Pa.). The cultured cells were grown in Dulbecco's Modified Eagle's Medium with 10% fetal bovine serum for 66 hours at 37° C. and 5% CO₂ before treating for 6 hours with 300 μM 5-fluorouracil and harvesting for total RNA isolation using the SV 96 Total RNA Isolation System (Promega, Madison, Wis.). RNA sample quality was evaluated by examining electrophoretic integrity of 18S and 28S rRNA bands on a 2100 Bioanalyzer instrument (Agilent, Santa Clara, Calif.) and by spectrophotometric absorbance at 230, 260 and 280 nm wavelengths on a Nanoprop 1000 (Nanoprop/Thermo Scientific, Wilmington, Del.). Preparation of cDNA from the RNA samples was carried out using 8 μl of total RNA into a standard 20 μl MMLV reverse transcriptase (Promega, Madison, Wis.) reaction according to the manufacturer's instructions using Promega buffers with an equimolar combination of random hexamers and oligo d(T) to prime the first strand synthesis. The resulting reaction products were diluted 10-fold with RNase free water and 5 μl of each cDNA solution dispensed into indexed positions on qPCR plates. The cDNAs in the plate were stabilized by drying under a laminar flow hood overnight and stored in a vacuum sealed pouch at room temperature until use. Real-time PCR data for human CDKN1A (SABiosciences catalog #PPH00211E) and ACTB (actin B) (SABiosciences catalog #PPH00073E) mRNAs were obtained by adding a 1× reaction chemistry premix (2×RT² SYBR Green PCR Master Mix (SABiosciences) diluted with water and PCR primer set) containing the primer pair for one of these genes to each well of the PCR plate, applying an appropriate optical seal to the plate and running in a real-time PCR instrument. The instrument-specific software was used to generate cycle threshold (Ct) values for each sample with both gene assays. The CDKN1A gene was the gene of interest, GOI, and the ACTB was the sample-to-sample normalizer or control gene. The relative levels of CDKN1A between samples were determined by the ΔΔCt method as described in Livak, K J and Schmittgen, 2001, Methods 25:402. The results of the relative comparison for each different transcription factor's ability to alter CDKN1A expression are shown in FIG. 1.

Tables 1-3 provide targets, sequence database references and primer sequences useful in the practice of an embodiment of the present invention.

Herein, a “panel of treatments” is the set of test conditions or compound for modulating (increasing or decreasing) gene expression. Parallel incubations of cells are with one test condition or agent which modulates expression of a gene of interest or a negative control which does not affect gene expression.

TABLE 1
siRNA Targets on the SureSilencing siRNA Array for Human
Transcription Factor Signaling Pathways (SABiosciences Catalog # SAH-075A)

| Ref Seq # | Gene | Description | PCR Primer # |
|---|---|---|---|
| NM_000044.2 | AR | Androgen receptor | PPH01016A |
| NM_005171.3 | ATF1 | Activating transcription factor 1 | PPH02010B |
| NM_001880.2 | ATF2 | Activating transcription factor 2 | PPH00071A |
| NM_001674.2 | ATF3 | Activating transcription factor 3 | PPH00408B |
| NM_005194.2 | CEBPB | CCAAT/enhancer binding protein (C/EBP), beta | PPH00991A |
| NM_001806.2 | CEBPG | CCAAT/enhancer binding protein (C/EBP), gamma | PPH02012A |
| NM_004379.3 | CREB1 | CAMP responsive element binding protein 1 | PPH00808E |
| NM_004380.2 | CREBBP | CREB binding protein (Rubinstein-Taybi syndrome) | PPH00324E |
| NM_001904.3 | CTNNB1 | Catenin, beta 1, | PPH00643E |
| NM_005225.2 | E2F1 | E2F transcription factor 1 | PPH00136F |
| NM_005229.3 | ELK1 | ELK1, member of ETS oncogene family | PPH00140B |
| NM_005252.3 | FOS | V-fos FBJ murine osteosarcoma viral oncogene homolog | PPH00094A |
| NM_021784.4 | FOXA2 | Forkhead box A2 | PPH00976A |
| NM_004821.2 | HAND1 | Heart and neural crest derivatives expressed 1 | PPH06879A |
| NM_004964.2 | HDAC1 | Histone deacetylase 1 | PPH01735E |
| NM_001530.3 | HIF1A | Hypoxia-inducible factor 1, alpha subunit | PPH01361B |
| NM_005526.2 | HSF1 | Heat shock transcription factor 1 | PPH00164E |
| NM_002165.2 | ID1 | Inhibitor of DNA binding 1, dominant negative helix-loop- | PPH00317A |
| | | helix protein | |
| NM_005354.4 | JUND | Jun D proto-oncogene | PPH00180E |
| NM_005587.2 | MEF2A | Myocyte enhancer factor 2A | PPH01480A |
| NM_002467.4 | MYC | V-myc myelocytomatosis viral oncogene homolog (avian) | PPH00100A |
| NM_006599.2 | NFAT5 | Nuclear factor of activated T-cells 5, tonicity-responsive | PPH01474A |
| NM_172390 | NFATC1 | Nuclear factor of activated T-cells, cytoplasmic, calcineurin- | PPH00277B |
| | | dependent 1 | |
| NM_004555.2 | NFATC3 | Nuclear factor of activated T-cells, cytoplasmic, calcineurin- | PPH01473A |
| | | dependent 3 | |
| NM_003998.2 | NFKB1 | Nuclear factor of kappa light polypeptide gene enhancer in | PPH00204E |
| | | B-cells 1 (p105) | |
| NM_002502.3 | NFKB2 | Nuclear factor of kappa light polypeptide gene enhancer in | PPH00782E |
| | | B-cells 2 (p49/p100) | |
| NM_005036.4 | PPARA | Peroxisome proliferative activated receptor, alpha | PPH01281B |
| NM_000321.2 | RB1 | Retinoblastoma 1 (including osteosarcoma) | PPH00228E |
| NM_002908.2 | REL | V-rel reticuloendotheliosis viral oncogene homolog (avian) | PPH00101B |
| NM_021975.3 | RELA | V-rel reticuloendotheliosis viral oncogene homolog A | PPH01812B |
| NM_006509.2 | RELB | V-rel reticuloendotheliosis viral oncogene homolog B | PPH00287A |
| NM_005901.4 | SMAD2 | SMAD family member 2 | PPH01949E |
| NM_005902.3 | SMAD3 | SMAD family member 3 | PPH01921B |
| NM_005359.5 | SMAD4 | SMAD family member 4 | PPH00134B |
| NM_005905.4 | SMAD9 | SMAD family member 9 | PPH00629A |
| NM_138473.2 | SP1 | Sp1 transcription factor | PPH01482A |
| NM_003150.3 | STAT3 | Signal transducer and activator of transcription 3 (acute- | PPH00708E |
| | | phase response factor) | |
| NM_003152.3 | STAT5A | Signal transducer and activator of transcription 5A | PPH00759A |
| NM_012448.3 | STAT5B | Signal transducer and activator of transcription 5B | PPH01972E |
| NM_003194.3 | TBP | TATA box binding protein | PPH01091E |
| NM_000546.4 | TP53 | Tumor protein p53 | PPH00213E |
| NM_003403.3 | YY1 | YY1 transcription factor | PPH00440E |
| SA_00112 | NEG | Negative Control siRNA (scrambled, nonsense sequence) | N/A |

TABLE 2
siRNA duplex oligonucleotide sequences on the siRNA array
targeting human transcription factors(all bases are
ribonucleotides unless otherwise indicated)

| | | | SEQ ID | | SEQ ID |
|---|---|---|---|---|---|
| Gene | Accession # | Sense strand (5′ to 3′) | NO | Guide strand (5′ to 3′) | NO |
| AR | NM_000044.2 | GCACCUCUCUCAAGAGUUU(dT)(dT) | 1 | AAACUCUUGAGAGAGGUGC(dC)(dT) | 2 |
| AR | NM_000044.2 | AGCCCAUCUUUCUGAAUGU(dT)(dT) | 3 | ACAUUCAGAAAGAUGGGCU(dG)(dA) | 4 |
| ATF1 | NM_005171.2 | GCUGCUGUCACUUCUAUGU(dT)(dT) | 5 | ACAUAGAAGUGACAGCAGC(dA)(dG) | 6 |
| ATF1 | NM_005171.2 | UACAGGGACUUCAGACAUU(dT)(dT) | 7 | AAUGUCUGAAGUCCCUGUA(dC)(dT) | 8 |
| ATF2 | NM_001880.2 | CGCCAUGCAGAAGAAAUCU(dT)(dT) | 9 | AGAUUUCUUCUGCAUGGCG(dG)(dT) | 10 |
| ATF2 | NM_001880.2 | AGUUACCAAUGGUGAUACU(dT)(dT) | 11 | AGUAUCACCAUUGGUAACU(dG)(dG) | 12 |
| ATF3 | NM_001674.2 | AGCAGCAUUUGAUAUACAU(dT)(dT) | 13 | AUGUAUAUCAAAUGCUGCU(dT)(dC) | 14 |
| ATF3 | NM_001674.2 | GAAGCUGGAAAGUGUGAAU(dT)(dT) | 15 | AUUCACACUUUCCAGCUUC(dT)(dC) | 16 |
| CEBPB | NM_005194.2 | UGAGUAAUCGCUUAAAGAU(dT)(dT) | 17 | AUCUUUAAGCGAUUACUCA(dG)(dG) | 18 |
| CEBPB | NM_005194.2 | AUGCAAUCGGUUUAAACAU(dT)(dT) | 19 | AUGUUUAAACCGAUUGCAU(dC)(dA) | 20 |
| CEBPG | NM_001806.2 | CACACUGCAGAGAGUCAAU(dT)(dT) | 21 | AUUGACUCUCUGCAGUGUG(dT)(dC) | 22 |
| CEBPG | NM_001806.2 | GCCGAGAGAGGAACAACAU(dT)(dT) | 23 | AUGUUGUUCCUCUCUCGGC(dG)(dT) | 24 |
| CREB1 | NM_004379.3 | CAGCAACCAAGUUGUUGUU(dT)(dT) | 25 | AACAACAACUUGGUUGCUG(dG)(dG) | 26 |
| CREB1 | NM_004379.3 | UCUGGAGACGUACAAACAU(dT)(dT) | 27 | AUGUUUGUACGUCUCCAGA(dG)(dG) | 28 |
| CREBBP | NM_004380.2 | GCCAUCUAGUGCAUAAACU(dT)(dT) | 29 | AGUUUAUGCACUAGAUGGC(dT)(dC) | 30 |
| CREBBP | NM_004380.2 | AGGCGUGUGUACAUUUCUU(dT)(dT) | 31 | AAGAAAUGUACACACGCCU(dC)(dG) | 32 |
| CTNNB1 | NM_001904.3 | AGUUCGCCUUCACUAUGGA(dT)(dT) | 33 | UCCAUAGUGAAGGCGAACU(dG)(dC) | 34 |
| CTNNB1 | NM_001904.3 | ACCAGGUGGUGGUUAAUAA(dT)(dT) | 35 | UUAUUAACCACCACCUGGU(dC)(dC) | 36 |
| E2F1 | NM_005225.2 | UCCAGCUCAUUGCCAAGAA(dT)(dT) | 37 | UUCUUGGCAAUGAGCUGGA(dT)(dG) | 38 |
| E2F1 | NM_005225.2 | UGGACCACCUGAUGAAUAU(dT)(dT) | 39 | AUAUUCAUCAGGUGGUCCA(dG)(dC) | 40 |
| ELK1 | NM_005229.3 | UGAAAUCGGAAGAGCUUAA(dT)(dT) | 41 | UUAAGCUCUUCCGAUUUCA(dG)(dG) | 42 |
| ELK1 | NM_005229.3 | GCCAGAAGUUCGUCUACAA(dT)(dT) | 43 | UUGUAGACGAACUUCUGGC(dC)(dG) | 44 |
| FOS | NM_005252.3 | UCUCCAGUGCCAACUUCAU(dT)(dT) | 45 | AUGAAGUUGGCACUGGAGA(dC)(dG) | 46 |
| FOS | NM_005252.3 | ACUGCUUACACGUCUUCCU(dT)(dT) | 47 | AGGAAGACGUGUAAGCAGU(dG)(dC) | 48 |
| FOXA2 | NM_021784.4 | AACACCACUACGCCUUCAA(dT)(dT) | 49 | UUGAAGGCGUAGUGGUGUU(dC)(dC) | 50 |
| FOXA2 | NM_021784.4 | CUCUCCUUCAACGACUGUU(dT)(dT) | 51 | AACAGUCGUUGAAGGAGAG(dC)(dG) | 52 |
| HAND1 | NM_004821.2 | CGCACUGAGAGCAUUAACA(dT)(dT) | 53 | UGUUAAUGCUCUCAGUGCG(dT)(dC) | 54 |
| HAND1 | NM_004821.2 | CGUGCAAUGUCCUUUGAUU(dT)(dT) | 55 | AAUCAAAGGACAUUGCACG(dT)(dG) | 56 |
| HDAC1 | NM_004964.2 | ACGGACAUCGCUGUGAAUU(dT)(dT) | 57 | AAUUCACAGCGAUGUCCGU(dC)(dT) | 58 |
| HDAC1 | NM_004964.2 | AAGUAUUAUGCUGUUAACU(dT)(dT) | 59 | AGUUAACAGCAUAAUACUU(dG)(dC) | 60 |
| HIF1A | NM_001530.3 | CCUAAUAGUCCCAGUGAAU(dT)(dT) | 61 | AUUCACUGGGACUAUUAGG(dC)(dT) | 62 |
| HIF1A | NM_001530.3 | UGGAGACACAAUCAUAUCU(dT)(dT) | 63 | AGAUAUGAUUGUGUCUCCA(dG)(dC) | 64 |
| HSF1 | NM_005526.2 | ACAUUCCAUGCCCAAGUAU(dT)(dT) | 65 | AUACUUGGGCAUGGAAUGU(dG)(dC) | 66 |
| HSF1 | NM_005526.2 | AUGCCCAGCAACAGAAAGU(dT)(dT) | 67 | ACUUUCUGUUGCUGGGCAU(dG)(dC) | 68 |
| ID1 | NM_002165.2 | GACAUGAACGGCUGUUACU(dT)(dT) | 69 | AGUAACAGCCGUUCAUGUC(dG)(dT) | 70 |
| ID1 | NM_002165.2 | ACGACAUGAACGGCUGUUA(dT)(dT) | 71 | UAACAGCCGUUCAUGUCGU(dA)(dG) | 72 |
| JUND | NM_005354.4 | GAUUCUGCCCUAUUUAUGU(dT)(dT) | 73 | ACAUAAAUAGGGCAGAAUC(dG)(dA) | 74 |
| JUND | NM_005354.4 | UGCCCUAUUUAUGUUUCUA(dT)(dT) | 75 | UAGAAACAUAAAUAGGGCA(dG)(dA) | 76 |
| MEF2A | NM_005587.2 | ACCCAAAGGAUCAGUAGUU(dT)(dT) | 77 | AACUACUGAUCCUUUGGGU(dG)(dT) | 78 |
| MEF2A | NM_005587.2 | AGCUCAACGUUAACAGAUU(dT)(dT) | 79 | AAUCUGUUAACGUUGAGCU(dG)(dG) | 80 |
| MYC | NM_002467.4 | GCUUGUACCUGCAGGAUCU(dT)(dT) | 81 | AGAUCCUGCAGGUACAAGC(dT)(dG) | 82 |
| MYC | NM_002467.4 | ACGACGAGACCUUCAUCAA(dT)(dT) | 83 | UUGAUGAAGGUCUCGUCGU(dC)(dC) | 84 |
| NFAT5 | NM_006599.2 | AGCAGACUUCUCACAUGAU(dT)(dT) | 85 | AUCAUGUGAGAAGUCUGCU(dG)(dG) | 86 |
| NFAT5 | NM_006599.2 | AGCAGAUUUCAUCAAAUAU(dT)(dT) | 87 | AUAUUUGAUGAAAUCUGCU(dG)(dC) | 88 |
| NFATC1 | NM_172390 | GCAGGACUCCAAGGUCAUU(dT)(dT) | 89 | AAUGACCUUGGAGUCCUGC(dA)(dG) | 90 |
| NFATC1 | NM_172390 | GGUUGAGAUCCCGCCAUUU(dT)(dT) | 91 | AAAUGGCGGGAUCUCAACC(dA)(dC) | 92 |
| NFATC3 | NM_004555 | ACCAACUUGUCUUCCUAUU(dT)(dT) | 93 | AAUAGGAAGACAAGUUGGU(dC)(dC) | 94 |
| NFATC3 | NM_004555 | GUCUCAGUUACAACCUAUU(dT)(dT) | 95 | AAUAGGUUGUAACUGAGAC(dG)(dA) | 96 |
| NFKB1 | NM_003998.2 | AUGACAGAGGCGUGUAUAA(dT)(dT) | 97 | UUAUACACGCCUCUGUCAU(dT)(dC) | 98 |
| NFKB1 | NM_003998.2 | ACCAUGGACACUGAAUCUA(dT)(dT) | 99 | UAGAUUCAGUGUCCAUGGU(dT)(dC) | 100 |
| NFKB2 | NM_002502.3 | AGGUGAUGGAUCUGAGUAU(dT)(dT) | 101 | AUACUCAGAUCCAUCACCU(dT)(dC) | 102 |
| NFKB2 | NM_002502.3 | AUGUGACUAAGAAGAACAU(dT)(dT) | 103 | AUGUUCUUCUUAGUCACAU(dG)(dC) | 104 |
| PPARA | NM_005036.4 | AGCAUUGAACAUCGAAUGU(dT)(dT) | 105 | ACAUUCGAUGUUCAAUGCU(dC)(dC) | 106 |
| PPARA | NM_005036.4 | AGGAAAGGCCAGUAACAAU(dT)(dT) | 107 | AUUGUUACUGGCCUUUCCU(dG)(dA) | 108 |
| RB1 | NM_000321.2 | UGCGCUCUUGAGGUUGUAA(dT)(dT) | 109 | UUACAACCUCAAGAGCGCA(dC)(dG) | 110 |
| RB1 | NM_000321.2 | ACUUGUAACAUCUAAUGGA(dT)(dT) | 111 | UCCAUUAGAUGUUACAAGU(dC)(dC) | 112 |
| REL | NM_002908.2 | AACAUGCUGUCUAAUUGUU(dT)(dT) | 113 | AACAAUUAGACAGCAUGUU(dG)(dG) | 114 |
| REL | NM_002908.2 | ACCAUCAAACAGUACUAAU(dT)(dT) | 115 | AUUAGUACUGUUUGAUGGU(dC)(dC) | 116 |
| RELA | NM_021975.3 | UGAGCACCAUCAACUAUGA(dT)(dT) | 117 | UCAUAGUUGAUGGUGCUCA(dG)(dG) | 118 |
| RELA | NM_021975.3 | CCUUCAAGAGCAUCAUGAA(dT)(dT) | 119 | UUCAUGAUGCUCUUGAAGG(dT)(dC) | 120 |
| RELB | NM_006509.2 | AGGAAGUAGACAUGAAUGU(dT)(dT) | 121 | ACAUUCAUGUCUACUUCCU(dG)(dA) | 122 |
| RELB | NM_006509.2 | AGAUCAUCGACGAGUACAU(dT)(dT) | 123 | AUGUACUCGUCGAUGAUCU(dC)(dC) | 124 |
| SMAD2 | NM_005901.4 | AGCCGUCUAUCAGCUAACU(dT)(dT) | 125 | AGUUAGCUGAUAGACGGCU(dT)(dC) | 126 |
| SMAD2 | NM_005901.4 | AACAGUUGAAUCAAAGUAU(dT)(dT) | 127 | AUACUUUGAUUCAACUGUU(dG)(dG) | 128 |
| SMAD3 | NM_005902.3 | GGACGAGGUCUGCGUGAAU(dT)(dT) | 129 | AUUCACGCAGACCUCGUCC(dT)(dT) | 130 |
| SMAD3 | NM_005902.3 | CUCAGUGACAGCGCUAUUU(dT)(dT) | 131 | AAAUAGCGCUGUCACUGAG(dG)(dC) | 132 |
| SMAD4 | NM_005359.5 | GCCUCCCAUUUCCAAUCAU(dT)(dT) | 133 | AUGAUUGGAAAUGGGAGGC(dT)(dG) | 134 |
| SMAD4 | NM_005359.5 | GUCUUUGUACAGAGUUACU(dT)(dT) | 135 | AGUAACUCUGUACAAAGAC(dC)(dG) | 136 |
| SMAD9 | NM_005905.4 | CCACCUAUCCUGACUCUUU(dT)(dT) | 137 | AAAGAGUCAGGAUAGGUGG(dC)(dG) | 138 |
| SMAD9 | NM_005905.4 | CCGAAGUGUGCUCAUAGAU(dT)(dT) | 139 | AUCUAUGAGCACACUUCGG(dG)(dA) | 140 |
| SP1 | NM_138473.2 | UCCAAGGCCUGGCUAAUAA(dT)(dT) | 141 | UUAUUAGCCAGGCCUUGGA(dG)(dG) | 142 |
| SP1 | NM_138473.2 | UGCCUAAUAUUCAGUAUCA(dT)(dT) | 143 | UGAUACUGAAUAUUAGGCA(dT)(dC) | 144 |
| STAT3 | NM_003150.3 | GCCUCUCUGCAGAAUUCAA(dT)(dT) | 145 | UUGAAUUCUGCAGAGAGGC(dT)(dG) | 146 |
| STAT3 | NM_003150.3 | AGAAGGACAUCAGCGGUAA(dT)(dT) | 147 | UUACCGCUGAUGUCCUUCU(dC)(dC) | 148 |
| STAT5A | NM_003152.3 | UCGAUCAGGAUGGAGAAUU(dT)(dT) | 149 | AAUUCUCCAUCCUGAUCGA(dG)(dT) | 150 |
| STAT5A | NM_003152.3 | GAAGUUCACAGUCCUGUUU(dT)(dT) | 151 | AAACAGGACUGUGAACUUC(dT)(dC) | 152 |
| STAT5B | NM_012448.3 | GGACUCAGUAGAUCUUGAU(dT)(dT) | 153 | AUCAAGAUCUACUGAGUCC(dC)(dA) | 154 |
| STAT5B | NM_012448.3 | GACUUGAAUUACCUUAUCU(dT)(dT) | 155 | AGAUAAGGUAAUUCAAGUC(dT)(dC) | 156 |
| TBP | NM_003194.3 | AGAAUUGUUCUCCUUAUUU(dT)(dT) | 157 | AAAUAAGGAGAACAAUUCU(dG)(dG) | 158 |
| TBP | NM_003194.3 | CACCAACAAUUUAGUAGUU(dT)(dT) | 159 | AACUACUAAAUUGUUGGUG(dG)(dG) | 160 |
| TP53 | NM_000546.4 | CCAUCUACAAGCAGUCACA(dT)(dT) | 161 | UGUGACUGCUUGUAGAUGG(dC)(dC) | 162 |
| TP53 | NM_000546.4 | ACGAUAUUGAACAAUGGUU(dT)(dT) | 163 | AACCAUUGUUCAAUAUCGU(dC)(dC) | 164 |
| YY1 | NM_003403.3 | ACACCAACUGGUUCAUACU(dT)(dT) | 165 | AGUAUGAACCAGUUGGUGU(dC)(dG) | 166 |
| YY1 | NM_003403.3 | UCUCAGAUCCCAAACAACU(dT)(dT) | 167 | AGUUGUUUGGGAUCUGAGA(dG)(dG) | 168 |
| NEG1 | SA_00108 | CAUAACGCGUAUACUCGAC(dT)(dT) | 169 | GUCGAGUAUACGCGUUAUG(dG)(dA) | 170 |
| NEG2 | SA_00109 | ACUAAGUACGUCGUAUUAC(dT)(dT) | 171 | GUAAUACGACGUACUUAGU(dG)(dT) | 172 |
| NEG3 | SA_00110 | UCGCGUCGGUAUCACGCGC(dT)(dT) | 173 | GCGCGUGAUACCGACGCGA(dC)(dT) | 174 |
| NEG4 | SA_00111 | AAUCUCAUUCGAUGCAUAC(dT)(dT) | 175 | GUAUGCAUCGAAUGAGAUU(dC)(dC) | 176 |

TABLE 3
Real-time PCR primers used to confirm the knockdown efficiency of the SureSilencing siRNAs

| | | | SEQ ID | | SEQ ID |
|---|---|---|---|---|---|
| Accession # | Gene | Forward (5′) qPCR Primer | NO | Reverse (3′) Primer | NO |
| NM_000044.2 | AR | CCATTGACTATTACTTTCCACC | 177 | CTTCCACATGTGAGAGCTCC | 178 |
| NM_005171.2 | ATF1 | TCCATTTACCCTACAGGTTTG | 179 | TTATTGGCAGAAATTACACACAC | 180 |
| NM_001880.2 | ATF2 | GCAACACCTATCATAAGAAGCA | 181 | CTCATCACTGGTAGTAGACTC | 182 |
| NM_001674.2 | ATF3 | CCAGGCTTTAGCATTATTGGATG | 183 | GGCCAGTGTGAGTGACTTCTC | 184 |
| NM_005194.2 | CEBPB | CAAGATGCGCAACCTGGAGA | 185 | GCTGCTTGAACAAGTTCCGC | 186 |
| NM_001806.2 | CEBPG | CAGCGGCTTACAGCAGGTTC | 187 | GGCGTTGCCGATACTCGTC | 188 |
| NM_004379.3 | CREB1 | GATCAGTAAACCAATCCCTTGAG | 189 | TGGTGGTGGTATGTAAGTGC | 190 |
| NM_004380.2 | CREBBP | TTGGGCAATCCAGATGTCG | 191 | TATACAGCATGAGACACAGCGTTG | 192 |
| NM_001904.3 | CTNNB1 | ACTTGCATTGTGATTGGCCTG | 193 | AATCCATTTGTATTGTTACTCCTCG | 194 |
| NM_005225.2 | E2F1 | AGGCCCTCGACTACCACTTC | 195 | AGCATCTCTGGAAACCCTG | 196 |
| NM_005229.3 | ELK1 | GACCCTTTCAATGTCCCTG | 197 | CCACTCTCTCTTGCCTAGAATAG | 198 |
| NM_005252.3 | FOS | GAATCCGAAGGGAAAGGAATAAG | 199 | CGCTTGGAGTGTATCAGTCAG | 200 |
| NM_021784.4 | FOXA2 | GGCCGCAGATACCTCCTACTA | 201 | TTTCTTCTCCCTTGCGTCTCT | 202 |
| NM_004821.2 | HAND1 | CCAGACGCAGGAAGATGAAAG | 203 | CTTGGAACTAAACAGGAAGTGC | 204 |
| NM_004964.2 | HDAC1 | TTCAGGCTCCTAAAGTAACATCAG | 205 | GGAGAAGACAGACAGAGGGCAG | 206 |
| NM_001530.3 | HIF1A | GGACAGCCTCACCAAACAGAG | 207 | TGACTCAAAGCGACAGATAACAC | 208 |
| NM_005526.2 | HSF1 | CGTGTCCTGTGGTTTGGTTG | 209 | ATCTCTGCCTGTCTTGTCCGTC | 210 |
| NM_002165.2 | ID1 | TGCTGCTCTACGACATGAACG | 211 | GATTCCGAGTTCAGCTCCAAC | 212 |
| NM_005354.4 | JUND | CATCGACATGGACACGCAG | 213 | CTCTTGAGGGTCTTCACTTTCTC | 214 |
| NM_005587.2 | MEF2A | GCTGGAGGGCAGTTATCTCAG | 215 | ATCCCGAGGAGGTGAAATC | 216 |
| NM_002467.4 | MYC | AGATCCGGAGCGAATAGGG | 217 | CCTTGCTCGGGTGTTGTAAGT | 218 |
| NM_006599.2 | NFAT5 | GTGTGGATTGGAATCTGAGCA | 219 | TCACAATCTCGTCGTTTGACC | 220 |
| NM_172390 | NFATC1 | TGCATGGCTACTTGGAGAATG | 221 | GGTGGTGGACACGGTCTTC | 222 |
| NM_004555 | NFATC3 | GATGAAGCAAGAACACAGAGAAG | 223 | GCAGATGGGATGAGGTCAC | 224 |
| NM_003998.2 | NFKB1 | GTCATTAAAGGTATCACGGTCG | 225 | AATGGCACATCAAGTGACTC | 226 |
| NM_002502.3 | NFKB2 | TCGGGACTTTCCTAAGCTG | 227 | AGATCCGGTGGAGAGCGAG | 228 |
| NM_005036.4 | PPARA | GAACGATTCGACTCAAGCTG | 229 | GACATCCCGACAGAAAGGCAC | 230 |
| NM_000321.2 | RB1 | GCCCTAGAGTGGGAGTCCTGATAAC | 231 | TGGTGAATGGGCAGTCAATC | 232 |
| NM_002908.2 | REL | TGCATTTGAGGGATCTGAC | 233 | TTGCATACTGCCAATACCTG | 234 |
| NM_021975.3 | RELA | AGTGAACCGAAACTCTGGCAG | 235 | GCACCTTGTCACACAGTAGGAAG | 236 |
| NM_006509.2 | RELB | TATCAGTGGTGTTCAGCAGGG | 237 | GTACGTGAAAGGCAATGGCTC | 238 |
| NM_005901.4 | SMAD2 | GGAAGTCCTTAGTGGCTGCATC | 239 | TTGACAATCATAGAACGAAAGC | 240 |
| NM_005902.3 | SMAD3 | GATTACCTTCACTATTCGGCCAG | 241 | ATGCTTAAACAGGTGCTCTGC | 242 |
| NM_005359.5 | SMAD4 | TTGGTTGCTAAGAAGCCTATAAG | 243 | GCAGAACAGTGAGACATTAGGTAG | 244 |
| NM_005905.4 | SMAD9 | TGCTGAGTATCATCGCCAG | 245 | TGGAGAGCCCATCTGAGTC | 246 |
| NM_138473.2 | SP1 | TCCCAACTTACAGAACCAGCA | 247 | GTTGGTTTGCACCTGGTATGA | 248 |
| NM_003150.3 | STAT3 | TGACATGGAGTTGACCTCG | 249 | CTGGAACCACAAAGTTAGTAGTTTC | 250 |
| NM_003152.3 | STAT5A | TGCATCTGTCCTCATGTGTTG | 251 | GAGTCTGGAGTCCACGTTCAC | 252 |
| NM_012448.3 | STAT5B | CAGCTCCGTGTGTGAGATGTG | 253 | GGCTAAATAACTAATCTGCCTTGAC | 254 |
| NM_003194.3 | TBP | CCTATTCTAAAGGGATTCAGGAAG | 255 | GGAGGCAAGGGTACATGAGAG | 256 |
| NM_000546.4 | TP53 | TGGCATTTGCACCTACCTCAC | 257 | AACTCCCTCTACCTAACCAGC | 258 |
| NM_003403.3 | YY1 | ATGCTCTATCTTGCTCTGTAATCTC | 259 | CATGAATTGTCCTCCTGTTG | 260 |

What is claimed is:

1. A kit comprising:
a) an array comprising, at defined locations, two or more stabilized biological samples comprising an analyte of interest, wherein the samples are desiccated; and
b) a mixture of reagents capable of detecting the analyte of interest in a container separate from the array.

2. The kit of claim 1, wherein the samples are prepared from cells treated in parallel with an agent or condition which modulates expression of at least one gene of interest.

3. The kit of claim 2, wherein the analyte of interest is selected from the group consisting of cDNA, DNA, RNA, protein and carbohydrate.

4. The kit of claim 2, wherein the samples comprise trehalose.

5. The kit of claim 3, wherein the analyte of interest is cDNA.

6. The kit of claim 5, wherein the agent which modulates the gene of interest is siRNA specific to said gene.

7. The kit of claim 6, wherein at least one gene of interest is set forth in Table 1.

8. The kit of claim 2, wherein the array comprises a sample prepared from cells treated in parallel with a negative control agent or condition which does not modulated expression of a gene of interest.

9. The kit of claim 7, wherein at least one siRNA comprises oligonucleotides in pairwise combinations selected from the group consisting of SEQ ID NOs:1 and 2, 3 and 4, 5 and 6, 7 and 8, 9 and 10, 11 and 12, 13 and 14, 15 and 16, 17 and 18, 19 and 20, 21 and 22, 23 and 24, 25 and 26, 27 and 28, 29 and 30, 31 and 32, 33 and 34, 35 and 36, 37 and 38, 39 and 40, 41 and 42, 43 and 44, 45 and 46, 47 and 48, 49 and 50, 51 and 52, 53 and 54, 55 and 56, 57 and 58, 59 and 60, 61 and 62, 63 and 64, 65 and 66, 67 and 68, 69 and 70, 71 and 72, 73 and 74, 75 and 76, 77 and 78, 79 and 80, 81 and 82, 83 and 84, 85 and 86, 87 and 88, 89 and 90, 91 and 92, 93 and 94, 95 and 96, 97 and 98, 99 and 100, 101 and 102, 103 and 104, 105 and 106, 107 and 108, 109 and 110, 111 and 112, 113 and 114, 115 and 116, 117 and 118, 119 and 120, 121 and 122, 123 and 124, 125 and 126, 127 and 128, 129 and 130, 131 and 132, 133 and 134, 135 and 136, 137 and 138, 139 and 140, 141 and 142, 143 and 144, 145 and 146, 147 and 148, 149 and 150, 151 and 152, 153 and 154, 155 and 156, 157 and 158, 159 and 160, 161 and 162, 163 and 164, 165 and 166, and 167 and 168.

10. The kit of claim 6, wherein the at least one sample is prepared from cells treated with a negative control siRNA comprising oligonucleotides in pairwise combination selected from the group consisting of SEQ ID NOs:169 and 170, 171 and 172, 173 and 174, and 175 and 176.

11. The kit of claim 8, wherein the at least one sample is prepared from cells treated with a negative control siRNA comprising oligonucleotides in pairwise combination selected from the group consisting of SEQ ID NOs:169 and 170, 171 and 172, 173 and 174, and 175 and 176.

12. A method for detecting modulation of gene expression in a cell of interest in response to a test condition, said method comprising the steps of:
a) selecting a panel of treatments, optionally from 4 to 384;
b) incubating the cell of interest in parallel under test conditions effecting the panel of treatments for a time sufficient to allow modulation of gene expression in response to at least one treatment within the panel of treatments, and optionally further comprising incubating a cell of interest in parallel with at least one negative control condition;
c) isolating a biological sample comprising an analyte of interest from the cells after step b;
d) dispensing the biological samples of step c at indexed positions of an array vessel;
e) immobilizing and/or stabilizing the biological samples in the array vessel;
f) optionally storing and optionally distributing the array of samples;
g) applying to the array a mixture of reagents capable of detecting the analyte of interest within the biological sample in an analysis reaction; and
h) measuring output of the analysis reaction of step g,
whereby modulation of expression of a gene of interest is determined when the output of the analysis reaction for the analyte of interest is different in the biological sample prepared from cells incubated under the test conditions than in a biological sample from control cells not treated with a test condition which modulates expression of the gene of interest.

13. The method of claim 12, wherein the test condition is treatment with at least one RNA molecule of from 18 to 100 nucleotides, which when introduced into or expressed in a cell inhibits transcription of a target sequence of the gene of interest complementary to a sequence of at least 9 nucleotides of the RNA molecule.

14. The method of claim 12, wherein the analyte of interest is a cDNA of known sequence.

15. The method of claim 14, wherein the analysis reaction is a Real Time Polymerase Chain Reaction.

16. The method of claim 12, wherein the treatment is an siRNA or shRNA, wherein said siRNA or shRNA is specific to the gene of interest and wherein said siRNA or shRNA modulates expression of at least one gene of interest by inhibiting expression of said gene of interest.

17. The method of claim 12, wherein the treatment is an siRNA or shRNA complementary to a mRNA encoding a transcription factor.

18. The method of claim 17, wherein the siRNA or shRNA is specific to one or more of the sequences encoding the transcription factors set forth in FIG. 1.

19. The method of claim 18, wherein the siRNA used to modulate expression of a human transcription factor comprises oligonucleotides in pairwise combinations selected from the group consisting of SEQ ID NOs:1 and 2, 3 and 4, 5 and 6, 7 and 8, 9 and 10, 11 and 12, 13 and 14, 15 and 16, 17 and 18, 19 and 20, 21 and 22, 23 and 24, 25 and 26, 27 and 28, 29 and 30, 31 and 32, 33 and 34, 35 and 36, 37 and 38, 39 and 40, 41 and 42, 43 and 44, 45 and 46, 47 and 48, 49 and 50, 51 and 52, 53 and 54, 55 and 56, 57 and 58, 59 and 60, 61 and 62, 63 and 64, 65 and 66, 67 and 68, 69 and 70, 71 and 72, 73 and 74, 75 and 76, 77 and 78, 79 and 80, 81 and 82, 83 and 84, 85 and 86, 87 and 88, 89 and 90, 91 and 92, 93 and 94, 95 and 96, 97 and 98, 99 and 100, 101 and 102, 103 and 104, 105 and 106, 107 and 108, 109 and 110, 111 and 112, 113 and 114, 115 and 116, 117 and 118, 119 and 120, 121 and 122, 123 and 124, 125 and 126, 127 and 128, 129 and 130, 131 and 132, 133 and 134, 135 and 136, 137 and 138, 139 and 140, 141 and 142, 143 and 144, 145 and 146, 147 and 148, 149 and 150, 151 and 152, 153 and 154, 155 and 156, 157 and 158, 159 and 160, 161 and 162, 163 and 164, 165 and 166, and 167 and 168.

20. The method of claim 16, wherein negative control condition is negative control siRNA comprising oligonucleotides in pairwise combination selected from the group consisting of SEQ ID NOs:169 and 170, 171 and 172, 173 and 174, and 175 and 176.

21. The method of claim 19, wherein negative control condition is negative control siRNA comprising oligonucleotides in pairwise combination selected from the group consisting of SEQ ID NOs:169 and 170, 171 and 172, 173 and 174, and 175 and 176.

22. The method of claim 19, wherein the inhibition of expression of a human transcription factor is assessed using a pair of oligonucleotide primers in a polymerase chain reaction assay, wherein the pair of oligonucleotide primers comprise sequences selected from the group consisting of SEQ ID NOs:177 and 178, 179 and 180, 181 and 182, 183 and 184, 185 and 186, 187 and 188, 189 and 190, 191 and 192, 193 and 194, 195 and 196, 197 and 198, 199 and 200, 201 and 202, 203 and 204, 205 and 206, 207 and 208, 209 and 210, 211 and 212, 213 and 214, 215 and 216, 217 and 218, 219 and 220, 221 and 222, 223 and 224, 225 and 226, 227 and 228, 229 and 230, 231 and 232, 233 and 234, 235 and 236, 237 and 238, 239 and 240, 241 and 242, 243 and 244, 245 and 246, 247 and 248, 249 and 250, and 251 and 260.

23. The method of claim 20, wherein the analyte of interest is a cDNA of known sequence.

24. The method of claim 23, wherein the analysis reaction is a Real Time Polymerase Chain Reaction.

25. The method of claim 16, wherein the treatment is a siRNA or shRNA specific for inhibiting expression of at least one gene encoding an apoptosis factor.

26. The method of claim 12, wherein the samples contain carbohydrate or protein and the analysis reaction is an immunological detection method.


SEQUENCE LISTING (260 sequences)

SEQ ID NO: 1 - DNA, 21 bp, Artificial Sequence
  Synthetic construct oligonucleotide
gcaccucucucaagaguuutt

SEQ ID NO: 2 - DNA, 21 bp, Artificial Sequence
  Synthetic construct  oligonucleotide
aaacucuugagagaggugcct

SEQ ID NO: 3 - DNA, 21 bp, Artificial Sequence
  Synthetic construct  oligonucletide
agcccaucuuucugaaugutt

SEQ ID NO: 4 - DNA, 21 bp, Artificial Sequence
  Synthetic construct  oligonucleotide
acauucagaaagaugggcuga

SEQ ID NO: 5 - DNA, 21 bp, Artificial Sequence
  Synthetic construct  oligonucleotide
gcugcugucacuucuaugutt

SEQ ID NO: 6 - DNA, 21 bp, Artificial Sequence
  Synthetic construct  oligonucleotide
acauagaagugacagcagcag

SEQ ID NO: 7 - DNA, 21 bp, Artificial Sequence
  Synthetic construct  oligonucleotide
uacagggacuucagacauutt

SEQ ID NO: 8 - DNA, 21 bp, Artificial Sequence
  Synthetic construct  oligonucleotide
aaugucugaagucccuguact

SEQ ID NO: 9 - DNA, 21 bp, Artificial Sequence
  Synthetic construct  oligonucleotide
cgccaugcagaagaaaucutt

SEQ ID NO: 10 - DNA, 21 bp, Artificial Sequence
  Synthetic construct  oligonucleotide
agauuucuucugcauggcggt

SEQ ID NO: 11 - DNA, 21 bp, Artificial Sequence
  Synthetic construct  oligonucleotide
aguuaccaauggugauacutt

SEQ ID NO: 12 - DNA, 21 bp, Artificial Sequence
  Synthetic construct  oligonucleotide
aguaucaccauugguaacugg

SEQ ID NO: 13 - DNA, 21 bp, Artificial Sequence
  Synthetic construct  oligonucleotide
agcagcauuugauauacautt

SEQ ID NO: 14 - DNA, 21 bp, Artificial Sequence
  Synthetic construct  oligonucleotide
auguauaucaaaugcugcutc

SEQ ID NO: 15 - DNA, 21 bp, Artificial Sequence
  Synthetic construct  oligonucleotide
gaagcuggaaagugugaautt

SEQ ID NO: 16 - DNA, 21 bp, Artificial Sequence
  Synthetic construct  oligonucleotide
auucacacuuuccagcuuctc

SEQ ID NO: 17 - DNA, 21 bp, Artificial Sequence
  Synthetic construct  oligonucleotide
ugaguaaucgcuuaaagautt

SEQ ID NO: 18 - DNA, 21 bp, Artificial Sequence
  Synthetic construct  oligonucleotide
aucuuuaagcgauuacucagg

SEQ ID NO: 19 - DNA, 21 bp, Artificial Sequence
  Synthetic construct  oligonucleotide
augcaaucgguuuaaacautt

SEQ ID NO: 20 - DNA, 21 bp, Artificial Sequence
  Synthetic construct  oligonucleotide
auguuuaaaccgauugcauca

SEQ ID NO: 21 - DNA, 21 bp, Artificial Sequence
  Synthetic construct  oligonucleotide
cacacugcagagagucaautt

SEQ ID NO: 22 - DNA, 21 bp, Artificial Sequence
  Synthetic construct  oligonucleotide
auugacucucugcagugugtc

SEQ ID NO: 23 - DNA, 21 bp, Artificial Sequence
  Synthetic construct  oligonucleotide
gccgagagaggaacaacautt

SEQ ID NO: 24 - DNA, 21 bp, Artificial Sequence
  Synthetic construct  oligonucleotide
auguuguuccucucucggcgt

SEQ ID NO: 25 - DNA, 21 bp, Artificial Sequence
  Synthetic construct  oligonucleotide
cagcaaccaaguuguuguutt

SEQ ID NO: 26 - DNA, 21 bp, Artificial Sequence
  Synthetic construct  oligonucleotide
aacaacaacuugguugcuggg

SEQ ID NO: 27 - DNA, 21 bp, Artificial Sequence
  Synthetic construct  oligonucleotide
ucuggagacguacaaacautt

SEQ ID NO: 28 - DNA, 21 bp, Artificial Sequence
  Synthetic construct  oligonucleotide
auguuuguacgucuccagagg

SEQ ID NO: 29 - DNA, 21 bp, Artificial Sequence
  Synthetic construct  oligonucleotide
gccaucuagugcauaaacutt

SEQ ID NO: 30 - DNA, 21 bp, Artificial Sequence
  Synthetic construct  oligonucleotide
aguuuaugcacuagauggctc

SEQ ID NO: 31 - DNA, 21 bp, Artificial Sequence
  Synthetic construct  oligonucleotide
aggcguguguacauuucuutt

SEQ ID NO: 32 - DNA, 21 bp, Artificial Sequence
  Synthetic construct  oligonucleotide
aagaaauguacacacgccucg

SEQ ID NO: 33 - DNA, 21 bp, Artificial Sequence
  Synthetic construct  oligonucleotide
aguucgccuucacuauggatt

SEQ ID NO: 34 - DNA, 21 bp, Artificial Sequence
  Synthetic construct  oligonucleotide
uccauagugaaggcgaacugc

SEQ ID NO: 35 - DNA, 21 bp, Artificial Sequence
  Synthetic construct  oligonucleotide
accagguggugguuaauaatt

SEQ ID NO: 36 - DNA, 21 bp, Artificial Sequence
  Synthetic construct  oligonucleotide
uuauuaaccaccaccuggucc

SEQ ID NO: 37 - DNA, 21 bp, Artificial Sequence
  Synthetic construct  oligonucleotide
uccagcucauugccaagaatt

SEQ ID NO: 38 - DNA, 21 bp, Artificial Sequence
  Synthetic construct  oligonucleotide
uucuuggcaaugagcuggatg

SEQ ID NO: 39 - DNA, 21 bp, Artificial Sequence
  Synthetic construct  oligonucleotide
uggaccaccugaugaauautt

SEQ ID NO: 40 - DNA, 21 bp, Artificial Sequence
  Synthetic construct  oligonucleotide
auauucaucaggugguccagc

SEQ ID NO: 41 - DNA, 21 bp, Artificial Sequence
  Synthetic construct  oligonucleotide
ugaaaucggaagagcuuaatt

SEQ ID NO: 42 - DNA, 21 bp, Artificial Sequence
  Synthetic construct  oligonucleotide
uuaagcucuuccgauuucagg

SEQ ID NO: 43 - DNA, 21 bp, Artificial Sequence
  Synthetic construct  oligonucleotide
gccagaaguucgucuacaatt

SEQ ID NO: 44 - DNA, 21 bp, Artificial Sequence
  Synthetic construct  oligonucleotide
uuguagacgaacuucuggccg

SEQ ID NO: 45 - DNA, 21 bp, Artificial Sequence
  Synthetic construct  oligonucleotide
ucuccagugccaacuucautt

SEQ ID NO: 46 - DNA, 21 bp, Artificial Sequence
  Synthetic construct  oligonucleotide
augaaguuggcacuggagacg

SEQ ID NO: 47 - DNA, 21 bp, Artificial Sequence
  Synthetic construct  oligonucleotide
acugcuuacacgucuuccutt

SEQ ID NO: 48 - DNA, 21 bp, Artificial Sequence
  Synthetic construct  oligonucleotide
aggaagacguguaagcagugc

SEQ ID NO: 49 - DNA, 21 bp, Artificial Sequence
  Synthetic construct  oligonucleotide
aacaccacuacgccuucaatt

SEQ ID NO: 50 - DNA, 21 bp, Artificial Sequence
  Synthetic construct  oligonucleotide
uugaaggcguagugguguucc

SEQ ID NO: 51 - DNA, 21 bp, Artificial Sequence
  Synthetic construct  oligonucleotide
cucuccuucaacgacuguutt

SEQ ID NO: 52 - DNA, 21 bp, Artificial Sequence
  Synthetic construct  oligonucleotide
aacagucguugaaggagagcg

SEQ ID NO: 53 - DNA, 21 bp, Artificial Sequence
  Synthetic construct  oligonucleotide
cgcacugagagcauuaacatt

SEQ ID NO: 54 - DNA, 21 bp, Artificial Sequence
  Synthetic construct  oligonucleotide
uguuaaugcucucagugcgtc

SEQ ID NO: 55 - DNA, 21 bp, Artificial Sequence
  Synthetic construct  oligonucleotide
cgugcaauguccuuugauutt

SEQ ID NO: 56 - DNA, 21 bp, Artificial Sequence
  Synthetic construct  oligonucleotide
aaucaaaggacauugcacgtg

SEQ ID NO: 57 - DNA, 21 bp, Artificial Sequence
  Synthetic construct  oligonucleotide
acggacaucgcugugaauutt

SEQ ID NO: 58 - DNA, 21 bp, Artificial Sequence
  Synthetic construct  oligonucleotide
aauucacagcgauguccguct

SEQ ID NO: 59 - DNA, 21 bp, Artificial Sequence
  Synthetic construct  oligonucleotide
aaguauuaugcuguuaacutt

SEQ ID NO: 60 - DNA, 21 bp, Artificial Sequence
  Synthetic construct  oligonucleotide
aguuaacagcauaauacuugc

SEQ ID NO: 61 - DNA, 21 bp, Artificial Sequence
  Synthetic construct  oligonucleotide
ccuaauagucccagugaautt

SEQ ID NO: 62 - DNA, 21 bp, Artificial Sequence
  Synthetic construct  oligonucleotide
auucacugggacuauuaggct

SEQ ID NO: 63 - DNA, 21 bp, Artificial Sequence
  Synthetic construct  oligonucleotide
uggagacacaaucauaucutt

SEQ ID NO: 64 - DNA, 21 bp, Artificial Sequence
  Synthetic construct  oligonucleotide
agauaugauugugucuccagc

SEQ ID NO: 65 - DNA, 21 bp, Artificial Sequence
  Synthetic construct  oligonucleotide
acauuccaugcccaaguautt

SEQ ID NO: 66 - DNA, 21 bp, Artificial Sequence
  Synthetic construct  oligonucleotide
auacuugggcauggaaugugc

SEQ ID NO: 67 - DNA, 21 bp, Artificial Sequence
  Synthetic construct  oligonucleotide
augcccagcaacagaaagutt

SEQ ID NO: 68 - DNA, 21 bp, Artificial Sequence
  Synthetic construct  oligonucleotide
acuuucuguugcugggcaugc

SEQ ID NO: 69 - DNA, 21 bp, Artificial Sequence
  Synthetic construct  oligonucleotide
gacaugaacggcuguuacutt

SEQ ID NO: 70 - DNA, 21 bp, Artificial Sequence
  Synthetic construct  oligonucleotide
aguaacagccguucaugucgt

SEQ ID NO: 71 - DNA, 21 bp, Artificial Sequence
  Synthetic construct  oligonucleotide
acgacaugaacggcuguuatt

SEQ ID NO: 72 - DNA, 21 bp, Artificial Sequence
  Synthetic construct  oligonucleotide
uaacagccguucaugucguag

SEQ ID NO: 73 - DNA, 21 bp, Artificial Sequence
  Synthetic construct  oligonucleotide
gauucugcccuauuuaugutt

SEQ ID NO: 74 - DNA, 21 bp, Artificial Sequence
  Synthetic construct  oligonucleotide
acauaaauagggcagaaucga

SEQ ID NO: 75 - DNA, 21 bp, Artificial Sequence
  Synthetic construct  oligonucleotide
ugcccuauuuauguuucuatt

SEQ ID NO: 76 - DNA, 21 bp, Artificial Sequence
  Synthetic construct  oligonucleotide
uagaaacauaaauagggcaga

SEQ ID NO: 77 - DNA, 21 bp, Artificial Sequence
  Synthetic construct  oligonucleotide
acccaaaggaucaguaguutt

SEQ ID NO: 78 - DNA, 21 bp, Artificial Sequence
  Synthetic construct  oligonucleotide
aacuacugauccuuugggugt

SEQ ID NO: 79 - DNA, 21 bp, Artificial Sequence
  Synthetic construct  oligonucleotide
agcucaacguuaacagauutt

SEQ ID NO: 80 - DNA, 21 bp, Artificial Sequence
  Synthetic construct  oligonucleotide
aaucuguuaacguugagcugg

SEQ ID NO: 81 - DNA, 21 bp, Artificial Sequence
  Synthetic construct  oligonucleotide
gcuuguaccugcaggaucutt

SEQ ID NO: 82 - DNA, 21 bp, Artificial Sequence
  Synthetic construct  oligonucleotide
agauccugcagguacaagctg

SEQ ID NO: 83 - DNA, 21 bp, Artificial Sequence
  Synthetic construct  oligonucleotide
acgacgagaccuucaucaatt

SEQ ID NO: 84 - DNA, 21 bp, Artificial Sequence
  Synthetic construct  oligonucleotide
uugaugaaggucucgucgucc

SEQ ID NO: 85 - DNA, 21 bp, Artificial Sequence
  Synthetic construct  oligonucleotide
agcagacuucucacaugautt

SEQ ID NO: 86 - DNA, 21 bp, Artificial Sequence
  Synthetic construct  oligonucleotide
aucaugugagaagucugcugg

SEQ ID NO: 87 - DNA, 21 bp, Artificial Sequence
  Synthetic construct  oligonucleotide
agcagauuucaucaaauautt

SEQ ID NO: 88 - DNA, 21 bp, Artificial Sequence
  Synthetic construct  oligonucleotide
auauuugaugaaaucugcugc

SEQ ID NO: 89 - DNA, 21 bp, Artificial Sequence
  Synthetic construct  oligonucleotide
gcaggacuccaaggucauutt

SEQ ID NO: 90 - DNA, 21 bp, Artificial Sequence
  Synthetic construct  oligonucleotide
aaugaccuuggaguccugcag

SEQ ID NO: 91 - DNA, 21 bp, Artificial Sequence
  Synthetic construct  oligonucleotide
gguugagaucccgccauuutt

SEQ ID NO: 92 - DNA, 21 bp, Artificial Sequence
  Synthetic construct  oligonucleotide
aaauggcgggaucucaaccac

SEQ ID NO: 93 - DNA, 21 bp, Artificial Sequence
  Synthetic construct  oligonucleotide
accaacuugucuuccuauutt

SEQ ID NO: 94 - DNA, 21 bp, Artificial Sequence
  Synthetic construct  oligonucleotide
aauaggaagacaaguuggucc

SEQ ID NO: 95 - DNA, 21 bp, Artificial Sequence
  Synthetic construct  oligonucleotide
gucucaguuacaaccuauutt

SEQ ID NO: 96 - DNA, 21 bp, Artificial Sequence
  Synthetic construct  oligonucleotide
aauagguuguaacugagacga

SEQ ID NO: 97 - DNA, 21 bp, Artificial Sequence
  Synthetic construct  oligonucleotide
augacagaggcguguauaatt

SEQ ID NO: 98 - DNA, 21 bp, Artificial Sequence
  Synthetic construct  oligonucleotide
uuauacacgccucugucautc

SEQ ID NO: 99 - DNA, 21 bp, Artificial Sequence
  Synthetic construct  oligonucleotide
accauggacacugaaucuatt

SEQ ID NO: 100 - DNA, 21 bp, Artificial Sequence
  Synthetic construct  oligonucleotide
uagauucaguguccauggutc

SEQ ID NO: 101 - DNA, 21 bp, Artificial Sequence
  Synthetic construct  oligonucleotide
aggugauggaucugaguautt

SEQ ID NO: 102 - DNA, 21 bp, Artificial Sequence
  Synthetic construct  oligonucleotide
auacucagauccaucaccutc

SEQ ID NO: 103 - DNA, 21 bp, Artificial Sequence
  Synthetic construct  oligonucleotide
augugacuaagaagaacautt

SEQ ID NO: 104 - DNA, 21 bp, Artificial Sequence
  Synthetic construct  oligonucleotide
auguucuucuuagucacaugc

SEQ ID NO: 105 - DNA, 21 bp, Artificial Sequence
  Synthetic construct  oligonucleotide
agcauugaacaucgaaugutt

SEQ ID NO: 106 - DNA, 21 bp, Artificial Sequence
  Synthetic construct  oligonucleotide
acauucgauguucaaugcucc

SEQ ID NO: 107 - DNA, 21 bp, Artificial Sequence
  Synthetic construct  oligonucleotide
aggaaaggccaguaacaautt

SEQ ID NO: 108 - DNA, 21 bp, Artificial Sequence
  Synthetic construct  oligonucleotide
auuguuacuggccuuuccuga

SEQ ID NO: 109 - DNA, 21 bp, Artificial Sequence
  Synthetic construct  oligonucleotide
ugcgcucuugagguuguaatt

SEQ ID NO: 110 - DNA, 21 bp, Artificial Sequence
  Synthetic construct  oligonucleotide
uuacaaccucaagagcgcacg

SEQ ID NO: 111 - DNA, 21 bp, Artificial Sequence
  Synthetic construct  oligonucleotide
acuuguaacaucuaauggatt

SEQ ID NO: 112 - DNA, 21 bp, Artificial Sequence
  Synthetic construct  oligonucleotide
uccauuagauguuacaagucc

SEQ ID NO: 113 - DNA, 21 bp, Artificial Sequence
  Synthetic construct  oligonucleotide
aacaugcugucuaauuguutt

SEQ ID NO: 114 - DNA, 21 bp, Artificial Sequence
  Synthetic construct  oligonucleotide
aacaauuagacagcauguugg

SEQ ID NO: 115 - DNA, 21 bp, Artificial Sequence
  Synthetic construct  oligonucleotide
accaucaaacaguacuaautt

SEQ ID NO: 116 - DNA, 21 bp, Artificial Sequence
  Synthetic construct  oligonucleotide
auuaguacuguuugauggucc

SEQ ID NO: 117 - DNA, 21 bp, Artificial Sequence
  Synthetic construct  oligonucleotide
ugagcaccaucaacuaugatt

SEQ ID NO: 118 - DNA, 21 bp, Artificial Sequence
  Synthetic construct  oligonucleotide
ucauaguugauggugcucagg

SEQ ID NO: 119 - DNA, 21 bp, Artificial Sequence
  Synthetic construct  oligonucleotide
ccuucaagagcaucaugaatt

SEQ ID NO: 120 - DNA, 21 bp, Artificial Sequence
  Synthetic construct  oligonucleotide
uucaugaugcucuugaaggtc

SEQ ID NO: 121 - DNA, 21 bp, Artificial Sequence
  Synthetic construct  oligonucleotide
aggaaguagacaugaaugutt

SEQ ID NO: 122 - DNA, 21 bp, Artificial Sequence
  Synthetic construct  oligonucleotide
acauucaugucuacuuccuga

SEQ ID NO: 123 - DNA, 21 bp, Artificial Sequence
  Synthetic construct  oligonucleotide
agaucaucgacgaguacautt

SEQ ID NO: 124 - DNA, 21 bp, Artificial Sequence
  Synthetic construct  oligonucleotide
auguacucgucgaugaucucc

SEQ ID NO: 125 - DNA, 21 bp, Artificial Sequence
  Synthetic construct  oligonucleotide
agccgucuaucagcuaacutt

SEQ ID NO: 126 - DNA, 21 bp, Artificial Sequence
  Synthetic construct  oligonucleotide
aguuagcugauagacggcutc

SEQ ID NO: 127 - DNA, 21 bp, Artificial Sequence
  Synthetic construct  oligonucleotide
aacaguugaaucaaaguautt

SEQ ID NO: 128 - DNA, 21 bp, Artificial Sequence
  Synthetic construct  oligonucleotide
auacuuugauucaacuguugg

SEQ ID NO: 129 - DNA, 21 bp, Artificial Sequence
  Synthetic construct  oligonucleotide
ggacgaggucugcgugaautt

SEQ ID NO: 130 - DNA, 21 bp, Artificial Sequence
  Synthetic construct  oligonucleotide
auucacgcagaccucgucctt

SEQ ID NO: 131 - DNA, 21 bp, Artificial Sequence
  Synthetic construct  oligonucleotide
cucagugacagcgcuauuutt

SEQ ID NO: 132 - DNA, 21 bp, Artificial Sequence
  Synthetic construct  oligonucleotide
aaauagcgcugucacugaggc

SEQ ID NO: 133 - DNA, 21 bp, Artificial Sequence
  Synthetic construct  oligonucleotide
gccucccauuuccaaucautt

SEQ ID NO: 134 - DNA, 21 bp, Artificial Sequence
  Synthetic construct  oligonucleotide
augauuggaaaugggaggctg

SEQ ID NO: 135 - DNA, 21 bp, Artificial Sequence
  Synthetic construct  oligonucleotide
gucuuuguacagaguuacutt

SEQ ID NO: 136 - DNA, 21 bp, Artificial Sequence
  Synthetic construct  oligonucleotide
aguaacucuguacaaagaccg

SEQ ID NO: 137 - DNA, 21 bp, Artificial Sequence
  Synthetic construct  oligonucleotide
ccaccuauccugacucuuutt

SEQ ID NO: 138 - DNA, 21 bp, Artificial Sequence
  Synthetic construct  oligonucleotide
aaagagucaggauagguggcg

SEQ ID NO: 139 - DNA, 21 bp, Artificial Sequence
  Synthetic construct  oligonucleotide
ccgaagugugcucauagautt

SEQ ID NO: 140 - DNA, 21 bp, Artificial Sequence
  Synthetic construct  oligonucleotide
aucuaugagcacacuucggga

SEQ ID NO: 141 - DNA, 21 bp, Artificial Sequence
  Synthetic construct  oligonucleotide
uccaaggccuggcuaauaatt

SEQ ID NO: 142 - DNA, 21 bp, Artificial Sequence
  Synthetic construct  oligonucleotide
uuauuagccaggccuuggagg

SEQ ID NO: 143 - DNA, 21 bp, Artificial Sequence
  Synthetic construct  oligonucleotide
ugccuaauauucaguaucatt

SEQ ID NO: 144 - DNA, 21 bp, Artificial Sequence
  Synthetic construct  oligonucleotide
ugauacugaauauuaggcatc

SEQ ID NO: 145 - DNA, 21 bp, Artificial Sequence
  Synthetic construct  oligonucleotide
gccucucugcagaauucaatt

SEQ ID NO: 146 - DNA, 21 bp, Artificial Sequence
  Synthetic construct  oligonucleotide
uugaauucugcagagaggctg

SEQ ID NO: 147 - DNA, 21 bp, Artificial Sequence
  Synthetic construct  oligonucleotide
agaaggacaucagcgguaatt

SEQ ID NO: 148 - DNA, 21 bp, Artificial Sequence
  Synthetic construct  oligonucleotide
uuaccgcugauguccuucucc

SEQ ID NO: 149 - DNA, 21 bp, Artificial Sequence
  Synthetic construct  oligonucleotide
ucgaucaggauggagaauutt

SEQ ID NO: 150 - DNA, 21 bp, Artificial Sequence
  Synthetic construct  oligonucleotide
aauucuccauccugaucgagt

SEQ ID NO: 151 - DNA, 21 bp, Artificial Sequence
  Synthetic construct  oligonucleotide
gaaguucacaguccuguuutt

SEQ ID NO: 152 - DNA, 21 bp, Artificial Sequence
  Synthetic construct  oligonucleotide
aaacaggacugugaacuuctc

SEQ ID NO: 153 - DNA, 21 bp, Artificial Sequence
  Synthetic construct  oligonucleotide
ggacucaguagaucuugautt

SEQ ID NO: 154 - DNA, 21 bp, Artificial Sequence
  Synthetic construct  oligonucleotide
aucaagaucuacugaguccca

SEQ ID NO: 155 - DNA, 21 bp, Artificial Sequence
  Synthetic construct  oligonucleotide
gacuugaauuaccuuaucutt

SEQ ID NO: 156 - DNA, 21 bp, Artificial Sequence
  Synthetic construct  oligonucleotide
agauaagguaauucaaguctc

SEQ ID NO: 157 - DNA, 21 bp, Artificial Sequence
  Synthetic construct  oligonucleotide
agaauuguucuccuuauuutt

SEQ ID NO: 158 - DNA, 21 bp, Artificial Sequence
  Synthetic construct  oligonucleotide
aaauaaggagaacaauucugg

SEQ ID NO: 159 - DNA, 21 bp, Artificial Sequence
  Synthetic construct  oligonucleotide
caccaacaauuuaguaguutt

SEQ ID NO: 160 - DNA, 21 bp, Artificial Sequence
  Synthetic construct  oligonucleotide
aacuacuaaauuguugguggg

SEQ ID NO: 161 - DNA, 21 bp, Artificial Sequence
  Synthetic construct  oligonucleotide
ccaucuacaagcagucacatt

SEQ ID NO: 162 - DNA, 21 bp, Artificial Sequence
  Synthetic construct  oligonucleotide
ugugacugcuuguagauggcc

SEQ ID NO: 163 - DNA, 21 bp, Artificial Sequence
  Synthetic construct  oligonucleotide
acgauauugaacaaugguutt

SEQ ID NO: 164 - DNA, 21 bp, Artificial Sequence
  Synthetic construct  oligonucleotide
aaccauuguucaauaucgucc

SEQ ID NO: 165 - DNA, 21 bp, Artificial Sequence
  Synthetic construct  oligonucleotide
acaccaacugguucauacutt

SEQ ID NO: 166 - DNA, 21 bp, Artificial Sequence
  Synthetic construct  oligonucleotide
aguaugaaccaguuggugucg

SEQ ID NO: 167 - DNA, 21 bp, Artificial Sequence
  Synthetic construct  oligonucleotide
ucucagaucccaaacaacutt

SEQ ID NO: 168 - DNA, 21 bp, Artificial Sequence
  Synthetic construct  oligonucleotide
aguuguuugggaucugagagg

SEQ ID NO: 169 - DNA, 21 bp, Artificial Sequence
  Synthetic construct  oligonucleotide
cauaacgcguauacucgactt

SEQ ID NO: 170 - DNA, 21 bp, Artificial Sequence
  Synthetic construct  oligonucleotide
gucgaguauacgcguuaugga

SEQ ID NO: 171 - DNA, 21 bp, Artificial Sequence
  Synthetic construct  oligonucleotide
acuaaguacgucguauuactt

SEQ ID NO: 172 - DNA, 21 bp, Artificial Sequence
  Synthetic construct  oligonucleotide
guaauacgacguacuuagugt

SEQ ID NO: 173 - DNA, 21 bp, Artificial Sequence
  Synthetic construct  oligonucleotide
ucgcgucgguaucacgcgctt

SEQ ID NO: 174 - DNA, 21 bp, Artificial Sequence
  Synthetic construct  oligonucleotide
gcgcgugauaccgacgcgact

SEQ ID NO: 175 - DNA, 21 bp, Artificial Sequence
  Synthetic construct  oligonucleotide
aaucucauucgaugcauactt

SEQ ID NO: 176 - DNA, 21 bp, Artificial Sequence
  Synthetic construct  oligonucleotide
guaugcaucgaaugagauucc

SEQ ID NO: 177 - DNA, 22 bp, Artificial Sequence
  Synthetic construct  oligonucleotide
ccattgactattactttccacc

SEQ ID NO: 178 - DNA, 20 bp, Artificial Sequence
  Synthetic construct  oligonucleotide
cttccacatgtgagagctcc

SEQ ID NO: 179 - DNA, 21 bp, Artificial Sequence
  Synthetic construct  oligonucleotide
tccatttaccctacaggtttg

SEQ ID NO: 180 - DNA, 23 bp, Artificial Sequence
  Synthetic construct  oligonucleotide
ttattggcagaaattacacacac

SEQ ID NO: 181 - DNA, 22 bp, Artificial Sequence
  Synthetic construct  oligonucleotide
gcaacacctatcataagaagca

SEQ ID NO: 182 - DNA, 21 bp, Artificial Sequence
  Synthetic construct  oligonucleotide
ctcatcactggtagtagactc

SEQ ID NO: 183 - DNA, 23 bp, Artificial Sequence
  Synthetic construct  oligonucleotide
ccaggctttagcattattggatg

SEQ ID NO: 184 - DNA, 21 bp, Artificial Sequence
  Synthetic construct  oligonucleotide
ggccagtgtgagtgacttctc

SEQ ID NO: 185 - DNA, 20 bp, Artificial Sequence
  Synthetic construct  oligonucleotide
caagatgcgcaacctggaga

SEQ ID NO: 186 - DNA, 20 bp, Artificial Sequence
  Synthetic construct  oligonucleotide
gctgcttgaacaagttccgc

SEQ ID NO: 187 - DNA, 20 bp, Artificial Sequence
  Synthetic construct  oligonucleotide
cagcggcttacagcaggttc

SEQ ID NO: 188 - DNA, 19 bp, Artificial Sequence
  Synthetic construct  oligonucleotide
ggcgttgccgatactcgtc

SEQ ID NO: 189 - DNA, 23 bp, Artificial Sequence
  Synthetic construct  oligonucleotide
gatcagtaaaccaatcccttgag

SEQ ID NO: 190 - DNA, 20 bp, Artificial Sequence
  Synthetic construct  oligonucleotide
tggtggtggtatgtaagtgc

SEQ ID NO: 191 - DNA, 19 bp, Artificial Sequence
  Synthetic construct  oligonucleotide
ttgggcaatccagatgtcg

SEQ ID NO: 192 - DNA, 24 bp, Artificial Sequence
  Synthetic construct  oligonucleotide
tatacagcatgagacacagcgttg

SEQ ID NO: 193 - DNA, 21 bp, Artificial Sequence
  Synthetic construct  oligonucleotide
acttgcattgtgattggcctg

SEQ ID NO: 194 - DNA, 25 bp, Artificial Sequence
  Synthetic construct  oligonucleotide
aatccatttgtattgttactcctcg

SEQ ID NO: 195 - DNA, 20 bp, Artificial Sequence
  Synthetic construct  oligonucleotide
aggccctcgactaccacttc

SEQ ID NO: 196 - DNA, 19 bp, Artificial Sequence
  Synthetic construct  oligonucleotide
agcatctctggaaaccctg

SEQ ID NO: 197 - DNA, 19 bp, Artificial Sequence
  Synthetic construct  oligonucleotide
gaccctttcaatgtccctg

SEQ ID NO: 198 - DNA, 23 bp, Artificial Sequence
  Synthetic construct  oligonucleotide
ccactctctcttgcctagaatag

SEQ ID NO: 199 - DNA, 23 bp, Artificial Sequence
  Synthetic construct  oligonucleotide
gaatccgaagggaaaggaataag

SEQ ID NO: 200 - DNA, 21 bp, Artificial Sequence
  Synthetic construct  oligonucleotide
cgcttggagtgtatcagtcag

SEQ ID NO: 201 - DNA, 21 bp, Artificial Sequence
  Synthetic construct  oligonucleotide
ggccgcagatacctcctacta

SEQ ID NO: 202 - DNA, 21 bp, Artificial Sequence
  Synthetic construct  oligonucleotide
tttcttctcccttgcgtctct

SEQ ID NO: 203 - DNA, 21 bp, Artificial Sequence
  Synthetic construct  oligonucleotide
ccagacgcaggaagatgaaag

SEQ ID NO: 204 - DNA, 22 bp, Artificial Sequence
  Synthetic construct  oligonucleotide
cttggaactaaacaggaagtgc

SEQ ID NO: 205 - DNA, 24 bp, Artificial Sequence
  Synthetic construct  oligonucleotide
ttcaggctcctaaagtaacatcag

SEQ ID NO: 206 - DNA, 22 bp, Artificial Sequence
  Synthetic construct  oligonucleotide
ggagaagacagacagagggcag

SEQ ID NO: 207 - DNA, 21 bp, Artificial Sequence
  Synthetic construct  oligonucleotide
ggacagcctcaccaaacagag

SEQ ID NO: 208 - DNA, 23 bp, Artificial Sequence
  Synthetic construct  oligonucleotide
tgactcaaagcgacagataacac

SEQ ID NO: 209 - DNA, 20 bp, Artificial Sequence
  Synthetic construct  oligonucleotide
cgtgtcctgtggtttggttg

SEQ ID NO: 210 - DNA, 22 bp, Artificial Sequence
  Synthetic construct  oligonucleotide
atctctgcctgtcttgtccgtc

SEQ ID NO: 211 - DNA, 21 bp, Artificial Sequence
  Synthetic construct  oligonucleotide
tgctgctctacgacatgaacg

SEQ ID NO: 212 - DNA, 21 bp, Artificial Sequence
  Synthetic construct  oligonucleotide
gattccgagttcagctccaac

SEQ ID NO: 213 - DNA, 19 bp, Artificial Sequence
  Synthetic construct  oligonucleotide
catcgacatggacacgcag

SEQ ID NO: 214 - DNA, 23 bp, Artificial Sequence
  Synthetic construct  oligonucleotide
ctcttgagggtcttcactttctc

SEQ ID NO: 215 - DNA, 21 bp, Artificial Sequence
  Synthetic construct  oligonucleotide
gctggagggcagttatctcag

SEQ ID NO: 216 - DNA, 19 bp, Artificial Sequence
  Synthetic construct  oligonucleotide
atcccgaggaggtgaaatc

SEQ ID NO: 217 - DNA, 19 bp, Artificial Sequence
  Synthetic construct  oligonucleotide
agatccggagcgaataggg

SEQ ID NO: 218 - DNA, 21 bp, Artificial Sequence
  Synthetic construct  oligonucleotide
ccttgctcgggtgttgtaagt

SEQ ID NO: 219 - DNA, 21 bp, Artificial Sequence
  Synthetic construct  oligonucleotide
gtgtggattggaatctgagca

SEQ ID NO: 220 - DNA, 21 bp, Artificial Sequence
  Synthetic construct  oligonucleotide
tcacaatctcgtcgtttgacc

SEQ ID NO: 221 - DNA, 21 bp, Artificial Sequence
  Synthetic construct  oligonucleotide
tgcatggctacttggagaatg

SEQ ID NO: 222 - DNA, 19 bp, Artificial Sequence
  Synthetic construct  oligonucleotide
ggtggtggacacggtcttc

SEQ ID NO: 223 - DNA, 23 bp, Artificial Sequence
  Synthetic construct  oligonucleotide
gatgaagcaagaacacagagaag

SEQ ID NO: 224 - DNA, 19 bp, Artificial Sequence
  Synthetic construct  oligonucleotide
gcagatgggatgaggtcac

SEQ ID NO: 225 - DNA, 22 bp, Artificial Sequence
  Synthetic construct  oligonucleotide
gtcattaaaggtatcacggtcg

SEQ ID NO: 226 - DNA, 20 bp, Artificial Sequence
  Synthetic construct  oligonucleotide
aatggcacatcaagtgactc

SEQ ID NO: 227 - DNA, 19 bp, Artificial Sequence
  Synthetic construct  oligonucleotide
tcgggactttcctaagctg

SEQ ID NO: 228 - DNA, 19 bp, Artificial Sequence
  Synthetic construct  oligonucleotide
agatccggtggagagcgag

SEQ ID NO: 229 - DNA, 20 bp, Artificial Sequence
  Synthetic construct  oligonucleotide
gaacgattcgactcaagctg

SEQ ID NO: 230 - DNA, 21 bp, Artificial Sequence
  Synthetic construct  oligonucleotide
gacatcccgacagaaaggcac

SEQ ID NO: 231 - DNA, 25 bp, Artificial Sequence
  Synthetic construct  oligonucleotide
gccctagagtgggagtcctgataac

SEQ ID NO: 232 - DNA, 20 bp, Artificial Sequence
  Synthetic construct  oligonucleotide
tggtgaatgggcagtcaatc

SEQ ID NO: 233 - DNA, 19 bp, Artificial Sequence
  Synthetic construct  oligonucleotide
tgcatttgagggatctgac

SEQ ID NO: 234 - DNA, 20 bp, Artificial Sequence
  Synthetic construct  oligonucleotide
ttgcatactgccaatacctg

SEQ ID NO: 235 - DNA, 21 bp, Artificial Sequence
  Synthetic construct  oligonucleotide
agtgaaccgaaactctggcag

SEQ ID NO: 236 - DNA, 23 bp, Artificial Sequence
  Synthetic construct  oligonucleotide
gcaccttgtcacacagtaggaag

SEQ ID NO: 237 - DNA, 21 bp, Artificial Sequence
  Synthetic construct  oligonucleotide
tatcagtggtgttcagcaggg

SEQ ID NO: 238 - DNA, 21 bp, Artificial Sequence
  Synthetic construct  oligonucleotide
gtacgtgaaaggcaatggctc

SEQ ID NO: 239 - DNA, 22 bp, Artificial Sequence
  Synthetic construct  oligonucleotide
ggaagtccttagtggctgcatc

SEQ ID NO: 240 - DNA, 22 bp, Artificial Sequence
  Synthetic construct  oligonucleotide
ttgacaatcatagaacgaaagc

SEQ ID NO: 241 - DNA, 23 bp, Artificial Sequence
  Synthetic construct  oligonucleotide
gattaccttcactattcggccag

SEQ ID NO: 242 - DNA, 21 bp, Artificial Sequence
  Synthetic construct  oligonucleotide
atgcttaaacaggtgctctgc

SEQ ID NO: 243 - DNA, 23 bp, Artificial Sequence
  Synthetic construct  oligonucleotide
ttggttgctaagaagcctataag

SEQ ID NO: 244 - DNA, 24 bp, Artificial Sequence
  Synthetic construct  oligonucleotide
gcagaacagtgagacattaggtag

SEQ ID NO: 245 - DNA, 19 bp, Artificial Sequence
  Synthetic construct  oligonucleotide
tgctgagtatcatcgccag

SEQ ID NO: 246 - DNA, 19 bp, Artificial Sequence
  Synthetic construct  oligonucleotide
tggagagcccatctgagtc

SEQ ID NO: 247 - DNA, 21 bp, Artificial Sequence
  Synthetic construct  oligonucleotide
tcccaacttacagaaccagca

SEQ ID NO: 248 - DNA, 21 bp, Artificial Sequence
  Synthetic construct  oligonucleotide
gttggtttgcacctggtatga

SEQ ID NO: 249 - DNA, 19 bp, Artificial Sequence
  Synthetic construct  oligonucleotide
tgacatggagttgacctcg

SEQ ID NO: 250 - DNA, 25 bp, Artificial Sequence
  Synthetic construct  oligonucleotide
ctggaaccacaaagttagtagtttc

SEQ ID NO: 251 - DNA, 21 bp, Artificial Sequence
  Synthetic construct  oligonucleotide
tgcatctgtcctcatgtgttg

SEQ ID NO: 252 - DNA, 21 bp, Artificial Sequence
  Synthetic construct  oligonucleotide
gagtctggagtccacgttcac

SEQ ID NO: 253 - DNA, 21 bp, Artificial Sequence
  Synthetic construct  oligonucleotide
cagctccgtgtgtgagatgtg

SEQ ID NO: 254 - DNA, 25 bp, Artificial Sequence
  Synthetic construct  oligonucleotide
ggctaaataactaatctgccttgac

SEQ ID NO: 255 - DNA, 24 bp, Artificial Sequence
  Synthetic construct  oligonucleotide
cctattctaaagggattcaggaag

SEQ ID NO: 256 - DNA, 21 bp, Artificial Sequence
  Synthetic construct  oligonucleotide
ggaggcaagggtacatgagag

SEQ ID NO: 257 - DNA, 21 bp, Artificial Sequence
  Synthetic construct  oligonucleotide
tggcatttgcacctacctcac

SEQ ID NO: 258 - DNA, 21 bp, Artificial Sequence
  Synthetic construct  oligonucleotide
aactccctctacctaaccagc

SEQ ID NO: 259 - DNA, 25 bp, Artificial Sequence
  Synthetic construct  oligonucleotide
atgctctatcttgctctgtaatctc

SEQ ID NO: 260 - DNA, 20 bp, Artificial Sequence
  Synthetic construct  oligonucleotide
catgaattgtcctcctgttg